(19) United States
(12) Patent Application Publication
(10) Pub. No.: US 2025/0217533 A1
(43) Pub. Date: Jul. 3, 2025

(54) METHOD FOR PROCESSING GRAPHIC ELEMENTS IN A LOGICAL TOPOLOGY DIAGRAM AND DEVICE

(71) Applicant: Persagy Science and Technology Co.,Ltd, Beijing (CN)

(72) Inventors: Qi SHEN, Beijing (CN); Xiaoyan PAN, Beijing (CN); Ting HAN, Beijing (CN); Lu MENG, Beijing (CN); Feifei LIU, Beijing (CN); Xuening Zhang, Beijing (CN)

(21) Appl. No.: 18/886,741

(22) Filed: Sep. 16, 2024

(30) Foreign Application Priority Data
Dec. 28, 2023 (CN) 202311835458.4
Dec. 28, 2023 (CN) 202311837380.X

(51) Int. Cl. G06F 30/13; G06T 11/60

(52) U.S. Cl. CPC G06F 30/13; G06T 11/60

(57) ABSTRACT

Provided are a method for processing graphic elements in a logical topology diagram and a device. The method includes: determining a target relationship diagram template from pre-built candidate relationship diagram templates according to acquired physical world data of a target building and a topology diagram generation requirement; determining matched target physical object data from the physical world data according to a graphic element individual logic screening condition in the target relationship diagram template; determining a plurality of target graphic elements and connection relationships of the plurality of target graphic elements which are in the logical topology diagram according to the target physical object data; and determining a final positioning result of the plurality of target graphic elements in the logical topology diagram according to container information determined according to target physical object data corresponding to each graphic element in the target relationship diagram template.

### CROSS-REFERENCE TO RELATED APPLICATION

This application claims priority to Chinese Patent Application No. 202311835458.4, filed on Dec. 28, 2023 and Chinese Patent Application No. 202311837380.X, filed on Dec. 28, 2023, the disclosures of which are incorporated herein by reference in their entireties.

### TECHNICAL FIELD

The present disclosure relates to the field of software engineering, in particular, to a method for processing graphic elements in a logical topology diagram and a device.

### BACKGROUND

In intelligent systems related to infrastructure such as architecture, municipal engineering and transportation, system diagrams are widely used for expressing the composition structure and the operating state of an electromechanical system. Common examples include distribution system diagrams, heating station system diagrams and cold source system diagrams. A system diagram is presented through a two-dimensional diagram, where specific physical connection relationships between graphics are expressed through connecting lines between the graphics, and thus the graphic composition of a complete system is drawn, which is referred to as a “logical topology diagram”.

Rectangles of various sizes in this type of diagrams represent different physical objects such as devices, systems and spaces and are referred to as graphic elements. Connecting lines between graphic elements represent certain types of pipeline connection relationships or certain types of service logical relationships. However, line connection between graphic elements in the logical topology diagram needs to be manually performed and cannot be automatically completed, which is inefficient. In addition, according to actual project data, graphic elements should be displayed according to specific transverse and longitudinal orders, and different graphic elements have specific relative position relationships. These display manners, sequencing manners and relative position relationships in specific engineering system diagrams need to be determined manually by engineers in professional domains and cannot be automatically determined, resulting in low efficiency of positioning in logical topology diagrams.

### SUMMARY

The present disclosure provides a method for processing graphic elements in a logical topology diagram, a method for determining graphic elements in a logical topology diagram, a method for positioning graphic elements in a logical topology diagram and a device. According to the technical solutions of the present disclosure, screening is performed on graphic element logic and line connection logic between graphic elements, so graphic elements and connection relationships in the logical topology diagram are quickly determined; and a completeness check is performed, so the accuracy of data logic in the logical topology diagram is effectively ensured.

According to an aspect of the present disclosure, a method for processing graphic elements in a logical topology diagram is provided. The method includes the steps described below.

Physical world data of a target building is acquired, and a target relationship diagram template is determined from pre-built candidate relationship diagram templates according to the physical world data and a topology diagram generation requirement, where the physical world data includes at least complete relationship representation information of spaces, systems and devices in the target building.

Matched target physical object data is determined from the physical world data according to a graphic element individual logic screening condition in the target relationship diagram template.

Multiple of target graphic elements and connection relationships of the multiple target graphic elements which are in the logical topology diagram corresponding to the target relationship diagram template are determined according to the target physical object data.

Container information is determined according to target physical object data corresponding to each graphic element in the target relationship diagram template, and a final positioning result of the multiple target graphic elements in the logical topology diagram corresponding to the target relationship diagram template is determined according to the container information, where the container information includes at least a container type and container relative position information of a graphic element in a container.

According to another aspect of the present disclosure, a method for determining graphic elements in a logical topology diagram is provided. The method includes the steps described below.

Physical world data of a target building is acquired, and a target relationship diagram template is determined from pre-built candidate relationship diagram templates according to the physical world data and a topology diagram generation requirement, where the physical world data includes at least complete relationship representation information of spaces, systems and devices in the target building.

Matched target physical object data is determined from the physical world data according to a graphic element individual logic screening condition in the target relationship diagram template.

Target association logic of the target physical object data is determined according to a graphic element association logic condition in the target relationship diagram template and the physical world data.

Multiple target graphic elements and connection relationships of the multiple target graphic elements which are in the logical topology diagram corresponding to the target relationship diagram template are determined according to the target physical object data and the target association logic.

According to another aspect of the present disclosure, a method for positioning graphic elements in a logical topology diagram is provided. The method includes the steps described below.

Physical world data of a target building is acquired, and a target relationship diagram template is determined from pre-built candidate relationship diagram templates according to the physical world data and a topology diagram generation requirement, where the physical world data includes at least complete relationship representation information of spaces, systems and devices in the target building.

Container information is determined according to target physical object data corresponding to each graphic element in the target relationship diagram template, where the container information includes at least a container type and container relative position information of a graphic element in a container, and the target physical object data is determined according to the physical world data.

Typesetting group relative position information of each typesetting group is determined according to the container information based on node typesetting information in a typesetting group tree corresponding to the target relationship diagram template, where the typesetting group tree includes at least one another typesetting group or at least one container.

A final positioning result of multiple target graphic elements in the logical topology diagram is determined according to the typesetting group relative position information of the each typesetting group and the container relative position information of the graphic element in the container.

According to another aspect of the present disclosure, an apparatus for processing graphic elements in a logical topology diagram is provided. The apparatus includes a relationship diagram template determination module, a physical object determination module, a relationship determination module and a positioning module.

The relationship diagram template determination module is configured to acquire physical world data of a target building, and determine a target relationship diagram template from pre-built candidate relationship diagram templates according to the physical world data and a topology diagram generation requirement, where the physical world data includes at least complete relationship representation information of spaces, systems and devices in the target building.

The physical object determination module is configured to determine matched target physical object data from the physical world data according to a graphic element individual logic screening condition in the target relationship diagram template.

The relationship determination module is configured to determine multiple target graphic elements and connection relationships of the multiple target graphic elements which are in the logical topology diagram corresponding to the target relationship diagram template according to the target physical object data.

The positioning module is configured to determine container information according to target physical object data corresponding to each graphic element in the target relationship diagram template, and determine a final positioning result of the multiple target graphic elements in the logical topology diagram corresponding to the target relationship diagram template according to the container information, where the container information includes at least a container type and container relative position information of a graphic element in a container.

According to another aspect of the present disclosure, an apparatus for determining graphic elements in a logical topology diagram is provided. The apparatus includes a relationship diagram template determination module, a physical object determination module, an association logic determination module and a graphic element and relationship determination module.

The relationship diagram template determination module is configured to acquire physical world data of a target building, and determine a target relationship diagram template from pre-built candidate relationship diagram templates according to the physical world data and a topology diagram generation requirement, where the physical world data includes at least complete relationship representation information of spaces, systems and devices in the target building.

The physical object determination module is configured to determine matched target physical object data from the physical world data according to a graphic element individual logic screening condition in the target relationship diagram template.

The association logic determination module is configured to determine target association logic of the target physical object data according to a graphic element association logic condition in the target relationship diagram template and the physical world data.

The graphic element and relationship determination module is configured to determine multiple target graphic elements and connection relationships of the multiple target graphic elements which are in the logical topology diagram corresponding to the target relationship diagram template according to the target physical object data and the target association logic.

According to another aspect of the present disclosure, a positioning apparatus of graphic elements in a logical topology diagram is provided. The apparatus includes a relationship diagram template determination module, a container information determination module, a relative position determination module and a graphic positioning determination module.

The relationship diagram template determination module is configured to acquire physical world data of a target building, and determine a target relationship diagram template from pre-built candidate relationship diagram templates according to the physical world data and a topology diagram generation requirement, where the physical world data includes at least complete relationship representation information of spaces, systems and devices in the target building.

The container information determination module is configured to determine container information according to target physical object data corresponding to each graphic element in the target relationship diagram template, where the container information includes at least a container type and container relative position information of a graphic element in a container, and the target physical object data is determined according to the physical world data.

The relative position determination module is configured to determine, based on node typesetting information in a typesetting group tree corresponding to the target relationship diagram template, typesetting group relative position information of each typesetting group according to the container information, where the typesetting group tree includes at least one another typesetting group or at least one container.

The graphic positioning determination module is configured to determine a final positioning result of multiple target graphic elements in the logical topology diagram according to the typesetting group relative position information of the each typesetting group and the container relative position information of the graphic element in the container.

According to another aspect of the present disclosure, an electronic device is provided and includes at least one processor and a memory communicatively connected to the at least one processor.

The memory stores a computer program executable by the at least one processor, and the computer program is executed by the at least one processor to cause the at least one processor to perform the method for processing graphic elements in a logical topology diagram according to any embodiment of the present disclosure.

According to another aspect of the present disclosure, a computer-readable storage medium is provided. The computer-readable storage medium is configured to store computer instructions configured to, when executed by a processor, cause the processor to perform the method for processing graphic elements in a logical topology diagram according to any embodiment of the present disclosure.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

To illustrate the technical solutions of the embodiments of the present disclosure more clearly, the drawings used in the description of the embodiments are described briefly hereinafter. Apparently, the drawings described below illustrate merely part of the embodiments of the present disclosure. Those of ordinary skill in the art may obtain other drawings based on these drawings on the premise that no creative work is done.

FIG. 1 is a flowchart of a method for processing graphic elements in a logical topology diagram according to an embodiment of the present disclosure;

FIG. 2 is a diagram of data logic composition of a logical topology diagram according to an embodiment of the present disclosure;

FIG. 3 is a flowchart of a method for determining graphic elements in a logical topology diagram according to an embodiment of the present disclosure;

FIG. 4 is a diagram showing a connection relationship between anchor points of two graphic elements according to an embodiment of the present disclosure;

FIG. 5 is a diagram showing another connection relationship between anchor points of two graphic elements according to an embodiment of the present disclosure;

FIG. 6 is a diagram showing a connection relationship where an anchor point itself represents an object connecting two graphic elements according to an embodiment of the present disclosure;

FIG. 7 is a flowchart of another method for determining graphic elements in a logical topology diagram according to an embodiment of the present disclosure;

FIG. 8 is a structural diagram of a target relationship network connected to a benchmark object according to an embodiment of the present disclosure;

FIG. 9 is a flowchart of a method for positioning graphic elements in a logical topology diagram according to an embodiment of the present disclosure;

FIG. 10 is a diagram showing the overall architecture of graphic element positioning and typesetting logic applicable to an embodiment of the present disclosure;

FIG. 11 is an example diagram of using water pumps as an instance of a device-type container according to an embodiment of the present disclosure;

FIG. 12 is an example diagram of using water pumps as an instance of a device-type container and merging water pumps according to an embodiment of the present disclosure;

FIG. 13 is an example diagram of using a pump house as an instance of a machine room-type container according to an embodiment of the present disclosure;

FIG. 14 is a structural diagram of a typesetting group tree according to an embodiment of the present disclosure;

FIG. 15 is a flowchart of a method for positioning graphic elements in a logical topology diagram according to an embodiment of the present disclosure;

FIG. 16 is a structural diagram of an apparatus for processing graphic elements in a logical topology diagram according to an embodiment of the present disclosure;

FIG. 17 is a structural diagram of an apparatus for determining graphic elements in a logical topology diagram according to an embodiment of the present disclosure;

FIG. 18 is a structural diagram of a positioning apparatus of graphic elements in a logical topology diagram according to an embodiment of the present disclosure; and

FIG. 19 is a structural diagram of an electronic device for implementing a method for processing graphic elements in a logical topology diagram according to an embodiment of the present disclosure.

### DETAILED DESCRIPTION

For a better understanding of the solutions of the present disclosure by those skilled in the art, the technical solutions in the embodiments of the present disclosure are described clearly and completely below in conjunction with the drawings in the embodiments of the present disclosure. Apparently, the embodiments described below are merely part, not all, of the embodiments of the present disclosure. Based on the embodiments of the present disclosure, all other embodiments obtained by those of ordinary skill in the art on the premise that no creative work is done are within the scope of the present disclosure.

It is to be noted that the terms “candidate”, “target” and the like in the description, claims and the preceding drawings of the present disclosure are used for distinguishing between similar objects and are not necessarily used for describing a particular order or sequence. It is to be understood that the data used in this manner is interchangeable in appropriate cases so that the embodiments of the present disclosure described herein may be implemented in an order not illustrated or described herein. Additionally, terms “including” and “having” as well as any variations thereof are intended to encompass a non-exclusive inclusion. For example, a process, method, system, product or device that includes a series of steps or units not only includes the expressly listed steps or units but may also include other steps or units that are not expressly listed or are inherent to such a process, method, product or device.

### Embodiment One

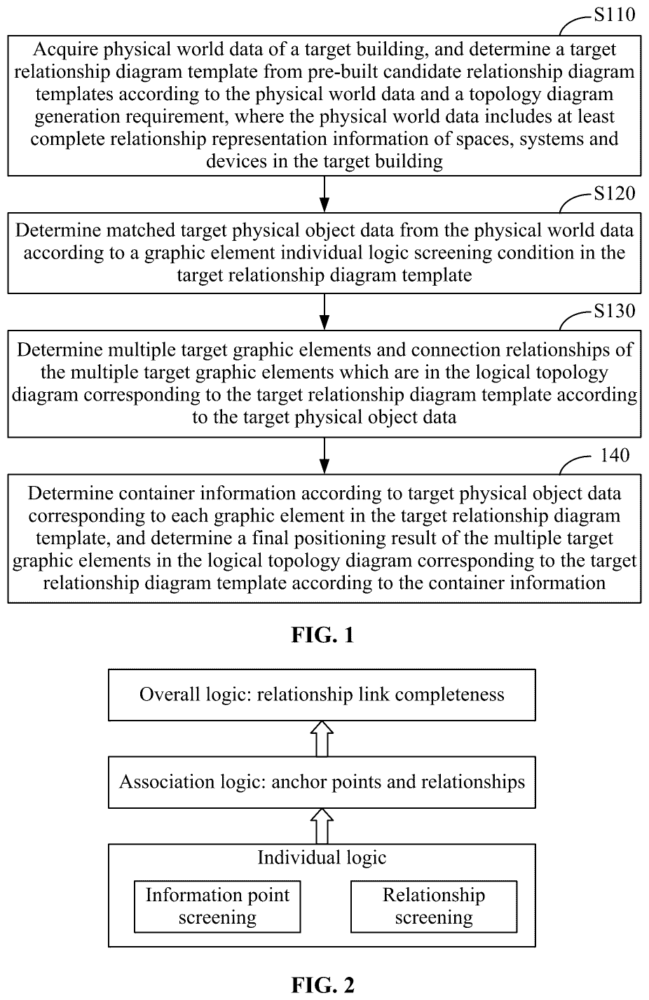

FIG. 1 is a flowchart of a method for processing graphic elements in a logical topology diagram according to an embodiment of the present disclosure. The embodiment is applicable to the case of processing graphic elements in a logical topology diagram. The method may be executed by an apparatus for processing graphic elements in a logical topology diagram, which may be implemented in form of hardware and/or software and may be configured in a system computer. As shown in FIG. 1, the method includes the steps described below.

In S110, physical world data of a target building is acquired, and a target relationship diagram template is determined from pre-built candidate relationship diagram templates according to the physical world data and a topology diagram generation requirement, where the physical world data includes at least complete relationship representation information of spaces, systems and devices in the target building.

In the embodiment of the present application, the target building refers to a specific building entity in the engineering field. The physical world data of the target building may be understood as the digital form of the target building and refers to the complete expression of objective physical information of a physical building, including spaces, systems, device objects, information points and relationship data in the physical building. The devices include two aspects, that is, device object information points and connection relationship data of device objects, respectively.

It is to be noted that the topology diagram generation requirement refers to the type of the logical topology diagram to be generated according to the needs of the user. The layout and display parameters of the logical topology diagram are part of the personalized display requirement of the generation requirement and are the display data drive for generating the logical topology diagram, including an image dimension requirement and whether a graphic element is specified to be displayed or hidden.

The candidate relationship diagram templates are standardized representation of a certain type of electromechanical systems and devices, including professional attribute information of composition, connection relationships and layout expression of specific electromechanical systems. This type of candidate relationship diagram templates are pre-stored in a database by the system for calling, and a target relationship diagram template type is determined from the candidate relationship diagram templates according to the specific data of the target building and the layout and display parameters of the topology diagram.

In S120, matched target physical object data is determined from the physical world data according to a graphic element individual logic screening condition in the target relationship diagram template.

In the embodiment of the present application, common relationship diagram templates include distribution system diagrams, heating station system diagrams, cold source system diagram, etc. Logical topology diagrams are various types of relationship diagrams, where specific physical connection relationships between graphics in these relationship diagrams are expressed through connecting lines between the graphics, and thus the graphic composition of a complete system is drawn. In a relationship diagram, rectangles of various sizes represent different physical objects such as devices, systems and spaces and are referred to as graphic elements.

The graphic element logic and the line connection logic between graphic elements involved in a logical topology diagram are collectively referred to as data logic. FIG. 2 is a diagram of data logic composition of a logical topology diagram. The entire data logic consists of three parts, that is, individual logic, association logic and overall logic.

It is to be noted that a specific graphic element in the target relationship diagram template corresponding to a physical building object in reality includes corresponding information point data and connection relationship data. Individual logic screening refers to performing screening from two perspectives, that is, information points and connection relationships, to determine a matched graphic element.

In an optional but not limited implementation, the step in which the matched target physical object data is determined from the physical world data according to the graphic element individual logic screening condition in the target relationship diagram template includes the step described below.

The matched target physical object data is determined from the physical world data according to a matching result between a static information point screening condition in the graphic element individual logic screening condition and candidate physical object information points in the physical world data.

The static information point screening condition includes at least one of the following logical combinations of data logic: an information point value being null or non-null, an information point value being a Boolean value, an information point value being an enumerated value, an information point value being a numerical value or an information point value being a character value.

In the embodiment of the present application, the individual logic screening refers to screening according to related logic of a graphic element in the relationship diagram template. The individual logic in the present disclosure refers to separate screening from two perspectives, that is, physical object information point data and connection relationship data. Screening performed on static information points of a physical object (such as a device, a system and a space) in the physical world data refers to screening performed on attribute information of the corresponding graphic element in the relationship diagram template. The static information points are used for representing the attribute information of the physical object represented by the graphic element, such as the manufacturer, the power and other attribute information that will not change with the operating state of the physical object.

Optionally, static information point includes four types, that is, a Boolean value, an enumerated value, a numerical value and a character value. For a static information point, several cases of data logic may be set, including: the value of the static information point is null or non-null; the value of the static information point is “yes” or “no” when the attribute of the static information point is a Boolean value; the value of the static information point is k or is not k (k is the enumerated item code of the enumerated value) when the attribute of the static information point is an enumerated value; the value of the static information point may be equal to A, not equal to A, larger than A, larger than or equal to A, smaller than A, smaller than or equal to A, larger than A and smaller than B, larger than or equal to A and smaller than B, larger than A and smaller than or equal to B, or larger than or equal to A and smaller than or equal to B (A and B are given numerical values) when the attribute of the static information point is a numerical value; the value of the static information point is including C or not including C (C is a given string) when the attribute of the static information point is a character value. In a cold source system diagram, the physical object being a chilled water pump is taken as an example and information point screening is performed. A chilled water pump graphic element connected to a chiller represents the device of the chilled water pump, but information point screening is required. Only the chilled water pump of which “the pipe network type=primary single-stage pump” is used. Multiple information point screening conditions may be set for the physical object referred to by a graphic element, and these conditions may be logically combined with “AND”, “OR” and “NOT” to form an overall screening and discrimination condition.

In an optional but not limited implementation, the step in which the matched target physical object data is determined from the physical world data according to the graphic element individual logic screening condition in the target relationship diagram template includes the step described below.

The matched target physical object data is determined from the physical world data according to a matching result between a connection relationship screening condition in the graphic element individual logic screening condition and candidate physical object connection relationships in the physical world data.

The connection relationship screening condition includes establishing a direct relationship or an indirect relationship with another graphic element, where the direct relationship is a preset relationship type, and the indirect relationship is level-by-level connection through at least two preset relationship types.

In the embodiment of the present application, a specific graphic element in the logical topology diagram refers to a physical object that satisfies a certain connection relationship, that is, only a target object that is “connected to a certain object” is presented. For example, a certain graphic element in relationship diagram template G refers to physical object A, and then the connection relationship screening condition corresponding to A may include four cases described below.

In the first case, a relationship screening condition is established with certain graphic element B in diagram G, and A has a direct relationship with B; then relationship type R from graphic element A to graphic element B is set, where R is a relationship type that can be established between A and B as specified in a data dictionary, and the data dictionary refers to a pre-established database that includes defined relationship types.

In the second case, a relationship screening condition is established with certain graphic element B in diagram G, and A has no direct relationship with B; then custom relationship type Rdef from graphic element A to graphic element B is set, where Rdef is formed by a series of relationship types connected level by level which are specified in the data dictionary; for example, Rdef(A, B)=R1(A, C)+R2(C, B).

In the third case, a relationship screening condition is established with object B (a non-graphic element) in the data dictionary, and A has a direct relationship with B; then relationship type R from graphic element A to object B (the non-graphic element) in the data dictionary is set, where R is the relationship type that can be established between A and B as specified in the data dictionary.

In the fourth case, a relationship screening condition is established with object B (the non-graphic element) in the data dictionary, and A has no direct relationship with B; then custom relationship type Rdef from graphic element A to object B (the non-graphic element) in the data dictionary is set, where Rdef is formed by a series of relationship types connected level by level which are specified in the data dictionary; for example, Rdef(A, B)=R1(A, C)+R2(C, B).

It is to be noted that the non-graphic element here represents not a graphic element in diagram G but a physical object in the physical world data. Although the non-graphic element does not appear in diagram G, screening can still be set for corresponding connection relationship data of the non-graphic element. Multiple relationship screening conditions may be set for the physical object referred to by a graphic element, and these conditions may be logically combined with “AND”, “OR” and “NOT” to form an overall relationship screening and discrimination condition.

In an optional but not limited implementation, the step in which the matched target physical object data is determined from the physical world data according to the graphic element individual logic screening condition in the target relationship diagram template includes the step described below.

The matched target physical object data is determined from the physical world data according to a matching result between an overall screening condition in the graphic element individual logic screening condition and the physical world data.

The overall screening condition is a logic combination of the static information point screening condition and the connection relationship screening condition.

In the embodiment of the present application, the overall screening condition is to limit the complete relationship representation information of the physical object, that is, to screen static information point data and connection relationship data of the graphic element. The information point screening condition and the relationship screening condition are determined according to the service logic corresponding to the template. Two or more screening conditions may be logically combined with “AND”, “OR” and “NOT” to form the final overall screening and discrimination condition.

In S130, multiple target graphic elements and connection relationships of the multiple target graphic elements which are in the logical topology diagram corresponding to the target relationship diagram template are determined according to the target physical object data.

Optionally, after the matched target physical object data is determined from the physical world data according to the matching result between the static information point screening condition in the graphic element individual logic screening condition and the candidate physical object information points in the physical world data, the target physical object data is analyzed so that relationships between graphic elements are determined, and then the multiple target graphic elements and the connection relationships of the multiple target graphic elements which are in the logical topology diagram corresponding to the target relationship diagram template are determined according to the determined relationship.

In the embodiment of the present application, the target graphic elements and anchor point connection relationships are determined by performing screening in the logical topology diagram through physical objects and physical relationships between physical objects in the physical world data, and then a target relationship diagram corresponding to the physical world data is generated, such as a distribution system diagram, a heating station system diagram and a cold source system diagram.

In S140, container information is determined according to target physical object data corresponding to each graphic element in the target relationship diagram template, and a final positioning result of the multiple target graphic elements in the logical topology diagram corresponding to the target relationship diagram template is determined according to the container information.

The container information includes at least a container type and container relative position information of a graphic element in a container.

Optionally, the target physical object data corresponding to each graphic element in the target relationship diagram template is acquired, and then according to the analysis on the data of each graphic element in the target physical object data, which type of container each graphic element corresponds to and the container relative position information of the graphic element in the container are determined.

In the embodiment of the present application, it can be understood that the basic unit in the finally generated logical topology diagram is the container. The relative position of the graphic element in the container is determined according to whether the layout setting manner of the container is transverse layout or longitudinal layout, whether the position for placing the container is a longitudinal position or a transverse position (including top alignment, bottom alignment and center alignment) and the spacing length between graphic elements in the container, the final position information of the multiple target graphic elements in the logical topology diagram is determined in combination with the overall size of the container in a typesetting group and nested relationships of typesetting groups, and then a target logical topology diagram is generated.

According to the technical solutions of the embodiment of the present disclosure, the multiple target graphic elements and the connection relationships of the multiple target graphic elements which are in the logical topology diagram corresponding to the target relationship diagram template are determined according to the target physical object data, so the graphic element and the connection relationship in the logical topology diagram are quickly determined, and the accuracy of data logic in the logical topology diagram is effectively ensured; moreover, the final positioning result of the target graphic elements in the logical topology diagram corresponding to the target relationship diagram template is determined according to the container information, so the graphic element in the logical topology diagram is positioned quickly and accurately.

### Embodiment Two

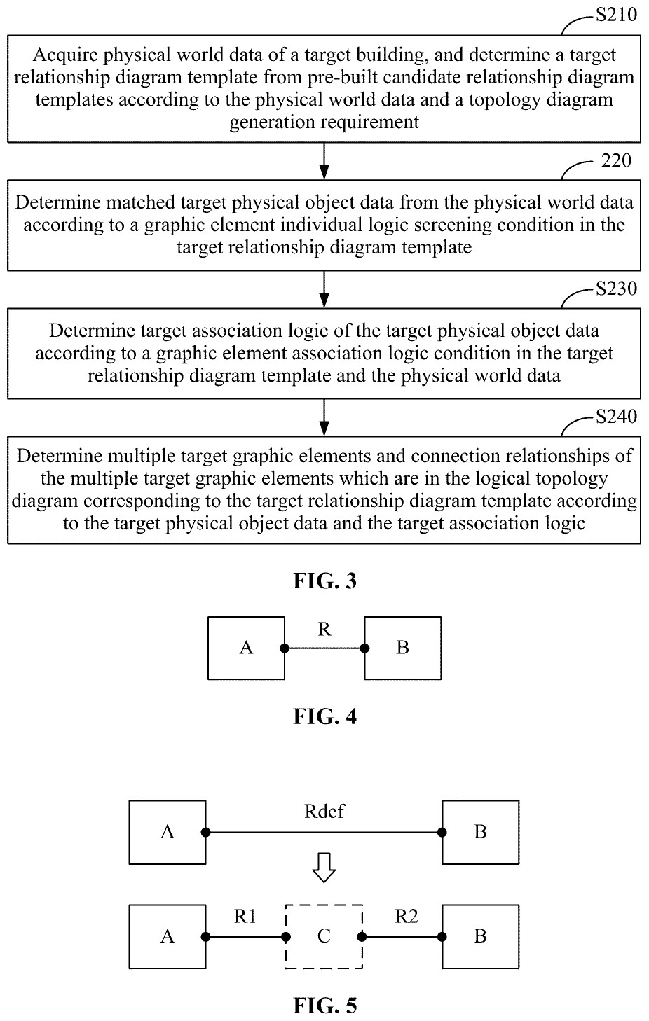

FIG. 3 is a flowchart of a method for determining graphic elements in a logical topology diagram according to an embodiment of the present disclosure. The embodiment is applicable to the case of determining graphic elements in a logical topology diagram. The embodiment further describes the preceding step in which the multiple target graphic elements and the connection relationships of the multiple target graphic elements which are in the logical topology diagram corresponding to the target relationship diagram template are determined according to the target physical object data, and can be combined with any optional embodiment in the preceding embodiments. As shown in FIG. 3, the method includes the steps described below.

In S210, physical world data of a target building is acquired, and a target relationship diagram template is determined from pre-built candidate relationship diagram templates according to the physical world data and a topology diagram generation requirement, where the physical world data includes at least complete relationship representation information of spaces, systems and devices in the target building.

In the embodiment of the present application, the target building refers to a specific building entity in the engineering field. The physical world data of the target building may be understood as the digital form of the target building and refers to the complete expression of objective physical information of a physical building, including spaces, systems, device objects, information points and relationship data in the physical building. The devices include two aspects, that is, device object information points and connection relationship data of device objects, respectively.

It is to be noted that the topology diagram generation requirement refers to the type of the logical topology diagram to be generated according to the needs of the user. The layout and display parameters of the logical topology diagram are part of the personalized display requirement of the generation requirement and are the display data drive for generating the logical topology diagram, including an image dimension requirement and whether a graphic element is specified to be displayed or hidden.

The candidate relationship diagram templates are standardized representation of a certain type of electromechanical systems and devices, including professional attribute information of composition, connection relationships and layout expression of specific electromechanical systems. This type of candidate relationship diagram templates are pre-stored in a database by the system for calling, and a target relationship diagram template type is determined from the candidate relationship diagram templates according to the specific data of the target building and the layout and display parameters of the topology diagram.

In S220, matched target physical object data is determined from the physical world data according to a graphic element individual logic screening condition in the target relationship diagram template.

In the embodiment of the present application, common relationship diagram templates include distribution system diagrams, heating station system diagrams, cold source system diagram, etc. Logical topology diagrams are various types of relationship diagrams, where specific physical connection relationships between graphics in these relationship diagrams are expressed through connecting lines between the graphics, and thus the graphic composition of a complete system is drawn. In a relationship diagram, rectangles of various sizes represent different physical objects such as devices, systems and spaces and are referred to as graphic elements.

The graphic element logic and the line connection logic between graphic elements involved in a logical topology diagram are collectively referred to as data logic. FIG. 2 is a diagram of data logic composition of a logical topology diagram. The entire data logic consists of three parts, that is, individual logic, association logic and overall logic.

It is to be noted that a specific graphic element in the target relationship diagram template corresponding to a physical building object in reality includes corresponding information point data and connection relationship data. Individual logic screening refers to performing screening from two perspectives, that is, information points and connection relationships, to determine a matched graphic element.

In an optional but not limited implementation, the step in which the matched target physical object data is determined from the physical world data according to the graphic element individual logic screening condition in the target relationship diagram template includes the step described below.

The matched target physical object data is determined from the physical world data according to a matching result between a static information point screening condition in the graphic element individual logic screening condition and candidate physical object information points in the physical world data.

The static information point screening condition includes at least one of the following logical combinations of data logic: an information point value being null or non-null, an information point value being a Boolean value, an information point value being an enumerated value, an information point value being a numerical value or an information point value being a character value.

In the embodiment of the present application, the individual logic screening refers to screening according to related logic of a graphic element in the relationship diagram template. The individual logic in the present disclosure refers to separate screening from two perspectives, that is, physical object information point data and connection relationship data. Screening performed on static information points of a physical object (such as a device, a system and a space) in the physical world data refers to screening performed on attribute information of the corresponding graphic element in the relationship diagram template. The static information points are used for representing the attribute information of the physical object represented by the graphic element, such as the manufacturer, the power and other attribute information that will not change with the operating state of the physical object.

Optionally, static information point includes four types, that is, a Boolean value, an enumerated value, a numerical value and a character value. For a static information point, several cases of data logic may be set, including: the value of the static information point is null or non-null; the value of the static information point is “yes” or “no” when the attribute of the static information point is a Boolean value; the value of the static information point is k or is not k (k is the enumerated item code of the enumerated value) when the attribute of the static information point is an enumerated value; the value of the static information point may be equal to A, not equal to A, larger than A, larger than or equal to A, smaller than A, smaller than or equal to A, larger than A and smaller than B, larger than or equal to A and smaller than B, larger than A and smaller than or equal to B, or larger than or equal to A and smaller than or equal to B (A and B are given numerical values) when the attribute of the static information point is a numerical value; the value of the static information point is including C or not including C (C is a given string) when the attribute of the static information point is a character value. In a cold source system diagram, the physical object being a chilled water pump is taken as an example and information point screening is performed. A chilled water pump graphic element connected to a chiller represents the device of the chilled water pump, but information point screening is required. Only the chilled water pump of which “the pipe network type=primary single-stage pump” is used. Multiple information point screening conditions may be set for the physical object referred to by a graphic element, and these conditions may be logically combined with “AND”, “OR” and “NOT” to form an overall screening and discrimination condition.

In an optional but not limited implementation, the step in which the matched target physical object data is determined from the physical world data according to the graphic element individual logic screening condition in the target relationship diagram template includes the step described below.

The matched target physical object data is determined from the physical world data according to a matching result between a connection relationship screening condition in the graphic element individual logic screening condition and candidate physical object connection relationships in the physical world data.

The connection relationship screening condition includes establishing a direct relationship or an indirect relationship with another graphic element, where the direct relationship is a preset relationship type, and the indirect relationship is level-by-level connection through at least two preset relationship types.

In the embodiment of the present application, a specific graphic element in the logical topology diagram refers to a physical object that satisfies a certain connection relationship, that is, only a target object that is “connected to a certain object” is presented. For example, a certain graphic element in relationship diagram template G refers to physical object A, and then the connection relationship screening condition corresponding to A may include four cases described below.

In the first case, a relationship screening condition is established with certain graphic element B in diagram G, and A has a direct relationship with B; then relationship type R from graphic element A to graphic element B is set, where R is a relationship type that can be established between A and B as specified in a data dictionary, and the data dictionary refers to a pre-established database that includes defined relationship types.

In the second case, a relationship screening condition is established with certain graphic element B in diagram G, and A has no direct relationship with B; then custom relationship type Rdef from graphic element A to graphic element B is set, where Rdef is formed by a series of relationship types connected level by level which are specified in the data dictionary; for example, Rdef(A, B)=R1(A, C)+R2(C, B).

In the third case, a relationship screening condition is established with object B (a non-graphic element) in the data dictionary, and A has a direct relationship with B; then relationship type R from graphic element A to object B (the non-graphic element) in the data dictionary is set, where R is the relationship type that can be established between A and B as specified in the data dictionary.

In the fourth case, a relationship screening condition is established with object B (the non-graphic element) in the data dictionary, and A has no direct relationship with B; then custom relationship type Rdef from graphic element A to object B (the non-graphic element) in the data dictionary is set, where Rdef is formed by a series of relationship types connected level by level which are specified in the data dictionary; for example, Rdef(A, B)=R1(A, C)+R2(C, B).

It is to be noted that the non-graphic element here represents not a graphic element in diagram G but a physical object in the physical world data. Although the non-graphic element does not appear in diagram G, screening can still be set for corresponding connection relationship data of the non-graphic element. Multiple relationship screening conditions may be set for the physical object referred to by a graphic element, and these conditions may be logically combined with “AND”, “OR” and “NOT” to form an overall relationship screening and discrimination condition.

In an optional but not limited implementation, the step in which the matched target physical object data is determined from the physical world data according to the graphic element individual logic screening condition in the target relationship diagram template includes the step described below.

The matched target physical object data is determined from the physical world data according to a matching result between an overall screening condition in the graphic element individual logic screening condition and the physical world data.

The overall screening condition is a logic combination of the static information point screening condition and the connection relationship screening condition.

In the embodiment of the present application, the overall screening condition is to limit the complete relationship representation information of the physical object, that is, to screen static information point data and connection relationship data of the graphic element. The information point screening condition and the relationship screening condition are determined according to the service logic corresponding to the template. Two or more screening conditions may be logically combined with “AND”, “OR” and “NOT” to form the final overall screening and discrimination condition.

In S230, target association logic of the target physical object data is determined according to a graphic element association logic condition in the target relationship diagram template and the physical world data.

In the embodiment of the present application, it is to be noted that in the logical topology diagram, a connecting line is used between graphic elements to express a specific physical connection relationship, so a complete system diagram is drawn. The target association logic refers to anchor connection information of the graphic element corresponding to the target physical object, that is, a connecting line between graphic elements. The graphic element association logic condition is used for representing a graphic element that satisfies a certain physical connection relationship.

In an optional but not limited implementation, the step in which the target association logic of the target physical object data is determined according to the graphic element association logic condition in the target relationship diagram template and the physical world data includes steps A1 and A2.

In step A1, an anchor point of the each graphic element in the target relationship diagram template and candidate connection logic in the target relationship diagram template are determined according to the graphic element association logic condition in the target relationship diagram template.

In step A2, anchor point connection information of the each graphic element is determined as the target association logic of the target physical object data according to the physical world data and the anchor point of the each graphic element in the target relationship diagram template and the candidate connection logic in the target relationship diagram template.

In the embodiment of the present application, the physical object represented by each graphic element has a point that can be connected, referred to as an anchor point. The candidate connection logic represents the connection relationship between the anchor point of the graphic element and anchor points on other graphic elements. The connection between anchor points represents the connection logic between physical objects, including connection relationships between devices, connection relationships between devices and spaces and connection relationships between systems and devices. Connection relationship data between anchor points of graphic elements in the target relationship diagram represents the target association logic of a target object.

In an optional but not limited implementation, the graphic element association logic condition includes: anchor point connection exists between two graphic elements of different types, the same connection relationship between two graphic elements corresponds to connection between a pair of anchor points, a connection relationship between the pair of anchor points includes a direction relationship or an indirect relationship, and an anchor point of the pair of anchor points represents a reference physical object, where information of the anchor point includes association logic between the reference physical object and a graphic element corresponding to the anchor point.

The direction relationship is a preset relationship type, and the indirect relationship is level-by-level connection through at least two preset relationship types.

In the embodiment of the present application, it is to be noted that the candidate connection logic between anchor points satisfies the characteristics described below.

An anchor point connecting line only connects anchor points of two different graphic elements, and no connecting line relationship exists between different anchor points of the same graphic element.

The same connection relationship between two graphic elements can only correspond to connection between a pair of anchor points.

An anchor point can be associated with multiple different connection relationships.

Connection relationship case 1 of two anchor points refers to a relationship type between two physical objects on two sides that is specified in a data dictionary, that is, relationship R is an establishable relationship between objects A and B on two sides that is specified in the dictionary. FIG. 4 is a diagram showing a connection relationship between anchor points of two graphic elements.

Connection relationship case 2 of two anchor points refers to a relationship type between two physical objects on two sides that is not specified in a data dictionary but can be formed by multiple levels (at least two levels) of relationship types specified in the data dictionary and connected level by level, that is, relationship Rdef(A, B)=R1(A, C)+R2(C, B). FIG. 5 is a diagram showing another connection relationship between anchor points of two graphic elements.

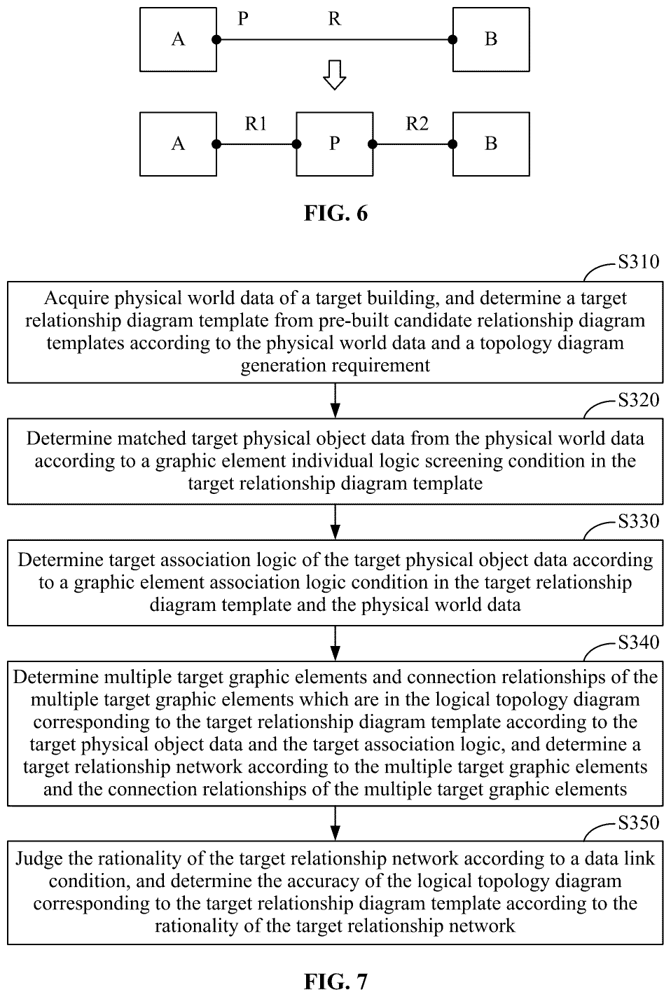

An anchor itself can represent a certain type of physical world objects, and the logical relationship between the object and the object represented by the graphic element needs to be declared. FIG. 6 is a diagram showing a connection relationship where an anchor point itself represents an object connecting two graphic elements.

When the anchor point itself represents a certain type of physical world objects, the connecting line may be the logical relationship between the anchor point object and the object referred to by another graphic element, and constraints are set to be the same as the preceding rules.

It is to be understood that the connecting line between anchor points may be a relationship already defined in data standards, or a defined multilevel relationship derived from the data standards.

Optionally, the anchor point position of each graphic element in the target relationship diagram template and connection relationship data that satisfies a certain physical relationship are determined, and the connection relationship between two anchor points is determined as the target association logic between two graphic elements according to the objective physical information of the target building represented by the graphic element, where the objective physical information includes spaces, systems, device objects, information points and relationship data of the target building.

In S240, multiple target graphic elements and connection relationships of the multiple target graphic elements which are in the logical topology diagram corresponding to the target relationship diagram template are determined according to the target physical object data and the target association logic.

In the embodiment of the present application, screening is performed in the logical topology diagram through physical objects and physical relationships between physical objects in the physical world data so that the target graphic elements and the anchor point connection relationships are determined, and then a target relationship diagram corresponding to the physical world data is generated, such as a distribution system diagram, a heating station system diagram and a cold source system diagram.

In the embodiment of the present application, physical world data of a target building is acquired, and a target relationship diagram template is determined from pre-built candidate relationship diagram templates according to the physical world data and a topology diagram generation requirement; matched target physical object data is determined from the physical world data according to a graphic element individual logic screening condition in the target relationship diagram template; target association logic of the target physical object data is determined according to a graphic element association logic condition in the target relationship diagram template and the physical world data; and the multiple target graphic elements and the connection relationships of the multiple target graphic elements which are in the logical topology diagram corresponding to the target relationship diagram template are determined according to the target physical object data and the target association logic. That is, according to the technical solutions of the embodiment, screening is performed on the graphic element logic and the line connection logic between graphic elements, so the graphic element and the connection relationship in the logical topology diagram are quickly determined; and a completeness check is performed, so the accuracy of data logic in the logical topology diagram is effectively ensured.

### Embodiment Three

FIG. 7 is a flowchart of a method for determining graphic elements in a logical topology diagram according to an embodiment of the present disclosure. The embodiment is a specific explanation of embodiment two. As shown in FIG. 7, the method includes the steps described below.

In S310, physical world data of a target building is acquired, and a target relationship diagram template is determined from pre-built candidate relationship diagram templates according to the physical world data and a topology diagram generation requirement, where the physical world data includes at least complete relationship representation information of spaces, systems and devices in the target building.

In S320, matched target physical object data is determined from the physical world data according to a graphic element individual logic screening condition in the target relationship diagram template.

In S330, target association logic of the target physical object data is determined according to a graphic element association logic condition in the target relationship diagram template and the physical world data.

In S340, multiple target graphic elements and connection relationships of the multiple target graphic elements which are in the logical topology diagram corresponding to the target relationship diagram template are determined according to the target physical object data and the target association logic, and a target relationship network is determined according to the multiple target graphic elements and the connection relationships of the multiple target graphic elements.

In the embodiment of the present application, screening is performed in the logical topology diagram through physical objects and physical relationships between physical objects in the physical world data so that the target graphic elements and the anchor point connection relationships are determined, and then a target relationship diagram corresponding to the physical world data is generated, such as a distribution system diagram, a heating station system diagram and a cold source system diagram. It is to be understood that each logical topology diagram involves multiple physical objects. According to the preceding relationship screening of the physical object, all physical objects in the topology diagram will be connected to form a relationship network through anchor point connection.

In S350, the rationality of the target relationship network is judged according to a data link condition, and the accuracy of the logical topology diagram corresponding to the target relationship diagram template is determined according to the rationality of the target relationship network, where the data link condition includes that the target relationship network does not include an independent relationship network, and the target relationship network does not include circular relationship logic.

In the embodiment of the present application, the graphic elements in the logical topology diagram are directly or indirectly connected to other graphic elements through anchor points to form a target relationship network. However, the preceding relationship screening and anchor point connection settings cannot ensure the rationality of the entire relationship network, so it is necessary to check the entire relationship network. FIG. 2 is a diagram of data logic composition of a logical topology diagram. The entire data logic consists of three parts, that is, individual logic, association logic and overall logic. The preceding embodiments have explained the individual logic and the association logic, and the overall logic in the embodiment is the completeness check on a data link relationship network.

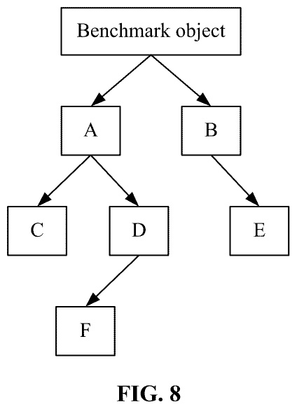

First, it is necessary to ensure that all physical objects are connected to the relationship network without isolated nodes or islands. In other words, a relationship diagram cannot include two unrelated small diagrams. Second, the relationship network cannot form a loop to avoid cyclic logic. Then, the relationship network must be connected to a benchmark object class, where the benchmark object class is used for representing types of candidate relationship diagram templates corresponding to candidate electromechanical systems or candidate devices, and a benchmark object class corresponds to at least one candidate relationship diagram template. The completeness of the data logic of the target relationship diagram is checked according to these discrimination conditions so that logical omissions or contradictions caused by local logic settings are avoided. FIG. 8 is a structural diagram of a target relationship network connected to a benchmark object. A, B, C, D, E and F represent other graphic elements in the target relationship diagram.

In the embodiment, physical world data of a target building is acquired, and a target relationship diagram template is determined from pre-built candidate relationship diagram templates according to the physical world data and a topology diagram generation requirement; matched target physical object data is determined from the physical world data according to a graphic element individual logic screening condition in the target relationship diagram template; target association logic of the target physical object data is determined according to a graphic element association logic condition in the target relationship diagram template and the physical world data; multiple target graphic elements and connection relationships of the multiple target graphic elements which are in the logical topology diagram corresponding to the target relationship diagram template are determined according to the target physical object data and the target association logic, and a target relationship network is determined according to the multiple target graphic elements and the connection relationships of the multiple target graphic elements; and the rationality of the target relationship network is judged according to a data link condition, and the accuracy of the logical topology diagram corresponding to the target relationship diagram template is determined according to the rationality of the target relationship network. That is, in the embodiment, the completeness of the entire logic of the target relationship diagram is automatically checked so that logical omissions or contradictions caused by local logic settings are avoided. In this manner, the accuracy of the data logic in the generated logical topology diagram is effectively ensured.

### Embodiment Four

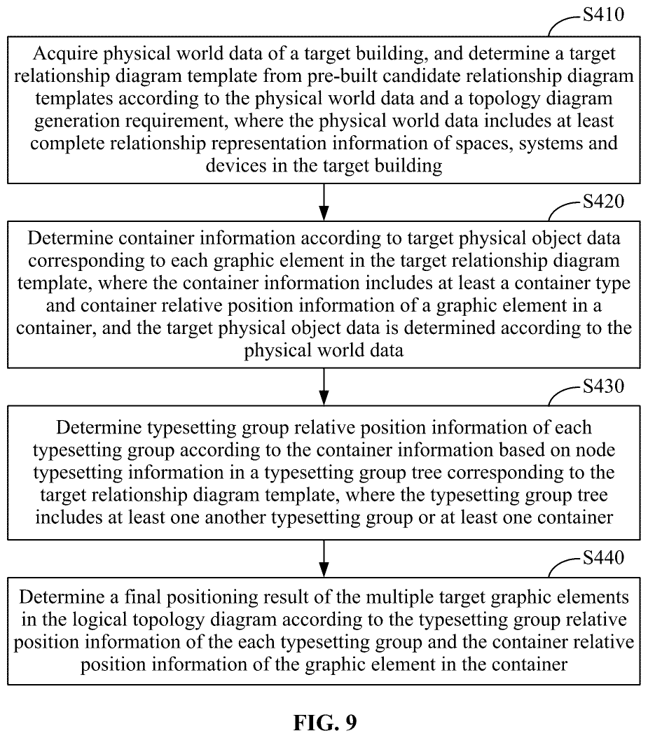

FIG. 9 is a flowchart of a method for positioning graphic elements in a logical topology diagram according to an embodiment of the present disclosure. The embodiment is applicable to the case of positioning graphic elements in a logical topology diagram. The embodiment further describes the preceding step in detail in which the container information is determined according to the target physical object data corresponding to the each graphic element in the target relationship diagram template, and the final positioning result of the multiple target graphic elements in the logical topology diagram corresponding to the target relationship diagram template is determined according to the container information, and can be combined with any optional embodiment in the preceding embodiments. As shown in FIG. 9, the method includes the steps described below.

In S410, physical world data of a target building is acquired, and a target relationship diagram template is determined from pre-built candidate relationship diagram templates according to the physical world data and a topology diagram generation requirement, where the physical world data includes at least complete relationship representation information of spaces, systems and devices in the target building.

In the embodiment of the present application, the target building refers to a specific building entity in the engineering field. The physical world data of the target building may be understood as the digital form of the target building and refers to the complete expression of objective physical information of a physical building, including spaces, systems, device objects, information points and relationship data in the physical building. The devices include two aspects, that is, device object information points and connection relationship data of device objects, respectively.

It is to be noted that the topology diagram generation requirement refers to the type of the logical topology diagram to be generated according to the needs of the user. The layout and display parameters of the logical topology diagram are part of the personalized display requirement of the generation requirement and are the display data drive for generating the logical topology diagram, including an image dimension requirement and whether a graphic element is specified to be displayed or hidden.

The candidate relationship diagram templates are standardized representation of a certain type of electromechanical systems and devices, including professional attribute information of composition, connection relationships and layout expression of specific electromechanical systems. This type of candidate relationship diagram templates are pre-stored in a database by the system for calling, and a target relationship diagram template type is determined from the candidate relationship diagram templates according to the specific data of the target building and the layout and display parameters of the topology diagram.

In S420, container information is determined according to target physical object data corresponding to each graphic element in the target relationship diagram template, where the container information includes at least a container type and container relative position information of a graphic element in a container, and the target physical object data is determined according to the physical world data.

Optionally, matched target physical object data is determined from the physical world data according to graphic element individual logic screening condition in the target relationship diagram template, and then the container information is determined according to the target physical object data corresponding to the each graphic element in the target relationship diagram template.

In the embodiment of the present application, common relationship diagram templates include distribution system diagrams, heating station system diagrams, cold source system diagram, etc. Logical topology diagrams are used for representing various types of relationship diagrams, where specific physical connection relationships between graphics in these relationship diagrams are expressed through connecting lines between the graphics, and thus the graphic composition of a complete system is drawn. In a relationship diagram, rectangles of various sizes represent different physical objects such as devices, systems and spaces and are referred to as graphic elements.

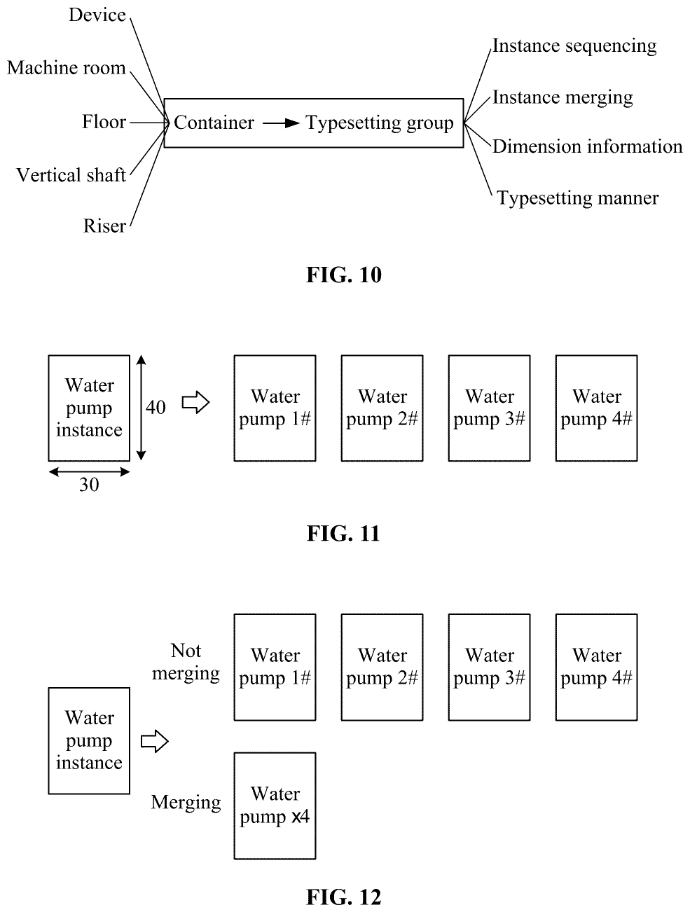

Graphic elements involved in a logical topology diagram need to be presented in a picture according to predetermined typesetting and layout logical conditions based on numbers of actual spaces, devices and systems of the project. The logic of describing the position, size and sequencing of each type of graphic elements during final drawing is referred to as graphic element positioning, typesetting and layout logic. FIG. 10 is a diagram showing the overall architecture of graphic element positioning, typesetting and layout logic.

Graphic elements that ultimately carry the positioning and layout function are referred to as containers and typesetting groups, where containers are a special type of typesetting groups. Containers represent a certain type of physical entity objects, which can be divided into five types, that is, devices, machine rooms, floors, vertical shafts and risers, according to different characteristics. According to actual project data, graphic elements referred to by containers should be displayed according to specific transverse and longitudinal orders, and different graphic elements have specific relative position relationships. When multiple containers are disposed in the logical topology diagram, the container relative position information includes layout setting manners between containers. If the containers are transversely laid out, longitudinal positions (including top alignment, bottom alignment and center alignment) of the containers may be set. If the containers are longitudinally laid out, transverse positions (including left alignment, right alignment and center alignment) of the containers may be set. The container relative position information further includes setting the spacing length between the containers.

In an optional but not limited implementation, the step in which the container information is determined according to the target physical object data corresponding to the each graphic element in the target relationship diagram template includes steps A1 and A2.

In step A1, the container type and graphic element attribute information in the container after instantiation are determined according to the target physical object data corresponding to the each graphic element, where the graphic element attribute information includes a physical object to which the graphic element corresponds and the number of graphic elements.

In step A2, corresponding container typesetting and layout information is determined according to the container type, and the container relative position information of the graphic element in the container is determined according to the container typesetting and layout information and the graphic element attribute information.

In the embodiment of the present application, containers include five types, that is, devices, machine rooms, floors, vertical shafts and risers. The container type is determined according to the target physical object. After the container type is determined, the graphic element represented by the container needs to be instantiated. The attribute information corresponding to the graphic element in the container includes the represented physical object and the number of graphic elements.

It is to be understood that, for example, the target physical object is a water pump, the corresponding container type of the graphic element is devices, and thus the graphic element attribute information includes the physical objects, that is, entity water pumps, corresponding to the graphic element and the number of set water pumps after the graphic element corresponding to the water pump in the template is instantiated according to the world physical data.

The typesetting and layout information of the container includes four aspects, that is, instance sequencing, instance merging, dimension information and typesetting manners. The container typesetting information is set, so graphic elements referred to by containers are displayed according to specific transverse and longitudinal orders, and different graphic elements have specific relative position relationships. Optionally, different container types have specific setting manners.

Layout setting manners of graphic elements in containers are set. If the containers are transversely laid out, longitudinal positions (including top alignment, bottom alignment and center alignment) of the containers may be set. If the containers are longitudinally laid out, transverse positions (including left alignment, right alignment and center alignment) of the containers may be set. The spacing length between containers may be set for jointly determining relative position relationships of containers.

In an optional but not limited implementation, the container type includes a device container type, a space container type, a floor container type, a vertical shaft container type and a riser container type.

The physical entity objects expressed by device-type containers are not limited to devices, but may also include other physical entities such as systems and spaces. The characteristic of a device-type container is that after instantiation of the container, the dimensions of each graphic element are fixed. For example, if the set dimensions of the water pump are 30 px×40 px (pixels), and four water pumps are obtained after instantiation, then the dimensions of each water pump are 30 px×40 px. FIG. 11 is an example diagram of using water pumps as an instance of a device-type container.

The positioning and typesetting manner of the device-type container includes the key elements described below.

A device-type container only corresponds to a physical object class and does not correspond to an empty container.

In the template, whether physical object instances are merged may be set. If physical object instances are merged, no subsequent setting is performed. FIG. 12 is an example diagram of using water pumps as an instance of a device-type container and merging water pumps.

In the template, whether physical object instances are transversely or longitudinally laid out in a container may be set.

In the template, when multiple physical object instances can be set, the spacing length between the physical object instances and pixels may be set.

If containers are transversely laid out, longitudinal positions may be set in the template, including top alignment, bottom alignment and center alignment.

If containers are longitudinally laid out, transverse positions may be set in the template, including left alignment, right alignment and center alignment.

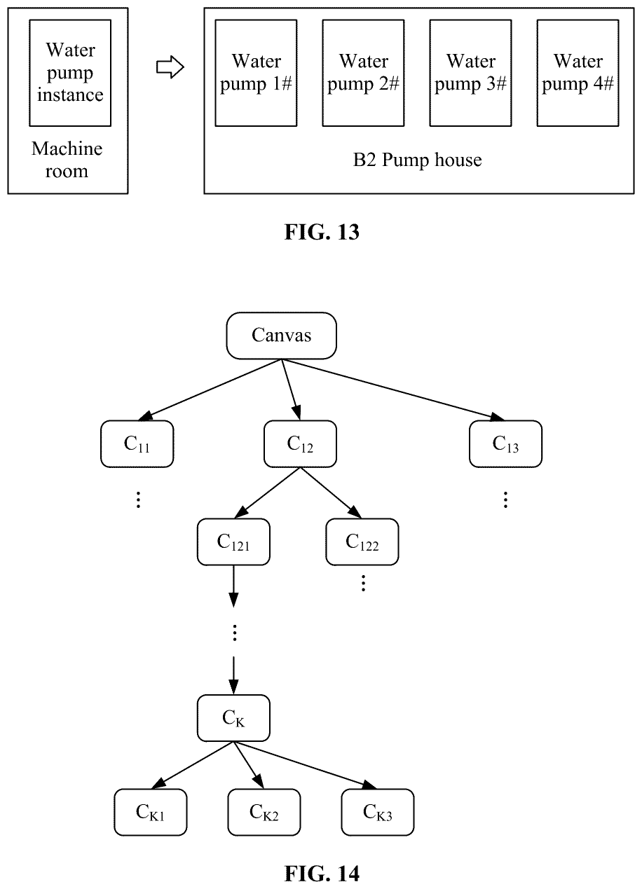

The physical entity objects expressed by machine room-type containers are not limited to machine rooms, but may also include non-machine room spaces, systems, distribution cabinets and other physical entities to represent space-type physical entity objects. The characteristic of a machine room-type container is that after instantiation of the container, the dimensions of each graphic element are not fixed but depend on the spatial position occupied by the instantiation result of the container in the machine room. FIG. 13 is an example diagram of using a pump house as an instance of a machine room-type container.

The positioning and typesetting manner of the machine room-type container includes the key elements described below.

A machine room-type container only corresponds to a physical object class and does not correspond to an empty container.

There must be a device container or a machine room container inside a machine room container, and the machine room container cannot be empty.

In the template, whether machine room-type instances are transversely or longitudinally laid out in a container may be set.

In the template, when multiple physical object instances can be set, the spacing length between the physical object instances and pixels may be set.

If containers are transversely laid out, longitudinal positions may be set in the template, including top alignment, bottom alignment and center alignment.

If containers are longitudinally laid out, transverse positions may be set in the template, including left alignment, right alignment and center alignment.

The floor-type containers are used for representing floor building entities. The characteristic of a floor-type container is that after instantiation of the container, floor graphic elements are arranged in floor order from bottom to top, and the floor graphic elements are aligned with the maximum floor width as the benchmark. The height of each floor is not fixed and depends on the spatial position occupied by an instantiated container within the floor. However, if no instantiated container exists within the floor, the floor is presented at a default height.

Vertical shaft-type containers are used for representing various vertical shaft entities, including ventilation shafts, water pipe shafts, electric wells, elevator shafts, stairwells, etc. Vertical shaft-type containers have the characteristics described below.

Vertical shaft-type containers are associated with floor-type containers for use, meaning that vertical shaft containers are inside floor containers by default.

After instantiation of the vertical shaft containers, according to the order of connection, vertical shaft container instances in the template are arranged according to floors from bottom to top.

Vertical shaft container groups that cannot communicate up and down are arranged in order from left to right in the template.

If the height of a vertical shaft is the same as the height of the floor where the vertical shaft is located, the width of the vertical shaft is determined by the spatial position occupied by an instantiated container in the vertical shaft. If no instantiated container exists in the vertical shaft, the vertical shaft is presented at a default width.

Riser-type containers are used for representing various types of longitudinal pipelines that run through multiple floors, including water pipes, air ducts and cables. Riser-type containers have the characteristics described below.

A riser-type container is associated with a vertical shaft-type container and a floor-type container for use, meaning that the riser-type container is inside the vertical shaft container and the floor container by default.

After instantiation of riser containers, according to the order of connection, riser container instances in the template are arranged according to floors from bottom to top.

Riser container groups that cannot communicate up and down are arranged in order from left to right in a vertical shaft or a floor in the template.

In the template, the height of a riser is the same as the height of the floor where the riser is located.

In S430, typesetting group relative position information of each typesetting group is determined according to the container information based on node typesetting information in a typesetting group tree corresponding to the target relationship diagram template, where the typesetting group tree includes at least one another typesetting group or at least one container.

In the embodiment of the present application, the typesetting group refers to a typesetting element that combines multiple containers and sets relative positions of these containers. The typesetting group may be multilevel nested, and the number of levels is not limited. That is, a typesetting group may include multiple other typesetting groups or containers, and thus the overall typesetting issue is converted into a “typesetting group tree”. The “typesetting group tree” is a tree structure diagram consisting of multiple typesetting groups. The “typesetting group tree” is predefined according to position information of graphic elements in the relationship diagram template. Each node in the typesetting group tree represents a typesetting group. The typesetting group relative position information is determined according to the container relative position information of the graphic element in the container and container overall size information. FIG. 14 is a structural diagram of a typesetting group tree.

Node typesetting information in the typesetting group tree includes supervisor-subordinate relationships of typesetting group nodes and downstream node layout information of the typesetting group nodes, where the supervisor-subordinate relationships of the typesetting group nodes represent nested relationships of typesetting groups.

For example, in the typesetting group tree, each typesetting group node includes information of a container or other typesetting groups included in the each typesetting group, as well as information of corresponding downstream typesetting group nodes, such as position arrangement information.

In S440, a final positioning result of multiple target graphic elements in the logical topology diagram is determined according to the typesetting group relative position information of the each typesetting group and the container relative position information of the graphic element in the container.

In the embodiment of the present application, it can be understood that the basic unit in the finally generated logical topology diagram is the container. The relative position of the graphic element in the container is determined according to whether the layout setting manner of the container is transverse layout or longitudinal layout, whether the position for placing the container is a longitudinal position or a transverse position (including top alignment, bottom alignment and center alignment) and the spacing length between graphic elements in the container, the final position information of the multiple target graphic elements in the logical topology diagram is determined in combination with the overall size of the container in the typesetting group and nested relationships of typesetting groups, and then a target logical topology diagram is generated.

In an optional but not limited implementation, the final positioning result of the multiple target graphic elements in the logical topology diagram is determined according to the typesetting group relative position information of the each typesetting group and the container relative position information of the graphic element in the container includes steps B1 to B3.

In step B1, absolute position information of a root node is determined.

In step B2, typesetting group absolute position information of downstream nodes of the root node is sequentially determined according to the typesetting group relative position information of the each typesetting group based on the absolute position information of the root node.

In step B3, graphic element absolute position information of the multiple target graphic elements in the logical topology diagram is determined as the final positioning result according to the typesetting group absolute position information and the container relative position information of the graphic element in the container.

In the embodiment of the present application, a root node typesetting group is typeset and positioned starting from coordinate point (0, 0) by default, while the other levels of typesetting groups are sequentially typeset and positioned according to set typesetting rules and relative position distances with the root node typesetting group as a benchmark point. That is, for any level, a typesetting group at this level is typeset with the upper left corner of the parent typesetting group as a relative origin. FIG. 14 is a structural diagram of a typesetting group tree. For example, C_{K1}, C_{K2} and C_{K3} included in C_{K} are transversely arranged and top aligned, so coordinates of upper left corners of C_{K1}, C_{K2} and C_{K3} can be calculated according to Table 1 below.

TABLE 1
Formulas for calculating coordinates of upper
left corners of child typesetting group nodes

| | X | Y |
|---|---|---|
| C_{K1} | X_{right}(C_{K}) + DX(K1, K) | Yₜₒₚ(C_{K}) + min{DY(K1, K), |
| C_{K2} | X_{right}(C_{K1}) + DX(K2, | DY(K2, K), DY(K3, K)} |
| | K1) | |
| C_{K3} | X_{right}(C_{K2}) + DX(K3, | |
| | K2) | |

C_{K} is the parent typesetting group node of C_{K1}, C_{K2} and C_{K3}, C_{K1}, C_{K2} and C_{K3} are child typesetting group nodes of C_{K}, and DX represents the preset typesetting group spacing length between two typesetting groups. Therefore, when the parent typesetting group and the child typesetting groups are transversely arranged and top aligned, the horizontal axis coordinate of the upper left corner of C_{K1} is the sum of the value of the horizontal axis coordinate of the upper right corner of C_{K} and the spacing length between two containers, the vertical axis coordinate of the upper left corner of C_{K1} is the sum of the value of the vertical axis coordinate of the upper right corner of C_{K} and the value of the minimum longitudinal spacing between two containers at this level. Since the typesetting manner is top alignment, the longitudinal spacing between two containers at this level is 0. Therefore, the vertical axis coordinate of the upper left corner of C_{K1} is the value of the vertical axis coordinate of the upper right corner of C_{K}. Coordinates of upper right corners of C_{K2} and C_{K3} are calculated in the similar manner, and this nested iteration process is performed until the upper left corner of the root node (the canvas) is the origin of coordinates, that is, X_{left}=0, and Yₜₒₚ=0. Then positioning is completed, and typesetting is automatically performed according to positioning results to form a diagram.

In the embodiment, physical world data of a target building is acquired, and a target relationship diagram template is determined from pre-built candidate relationship diagram templates according to the physical world data and a topology diagram generation requirement; container information is determined according to target physical object data corresponding to each graphic element in the target relationship diagram template; typesetting group relative position information of each typesetting group is determined according to the container information based on node typesetting information in a typesetting group tree corresponding to the target relationship diagram template; and a final positioning result of multiple target graphic elements in the logical topology diagram is determined according to the typesetting group relative position information of the each typesetting group and the container relative position information of the graphic element in the container. That is, according to the technical solutions of the embodiment, each node is drawn in the local typesetting manner through the typesetting group tree, so the graphic element in the logical topology diagram is quickly and accurately positioned.

### Embodiment Five

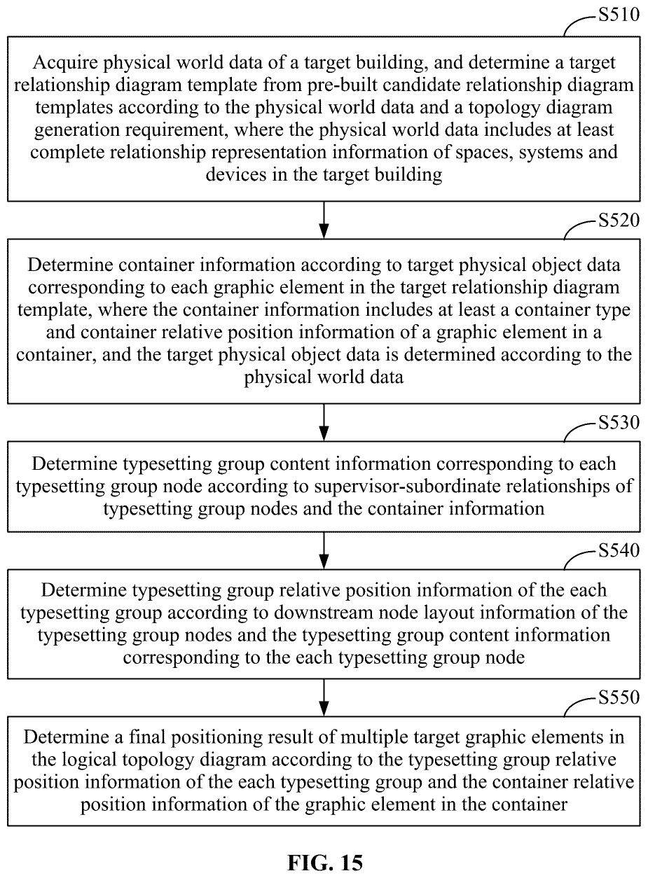

FIG. 15 is a flowchart of a method for positioning graphic elements in a logical topology diagram according to an embodiment of the present disclosure. The embodiment further describes the preceding embodiment four. For solutions that are not described in detail in the embodiment of the present application, reference is made to the preceding embodiments. As shown in FIG. 15, the method includes the steps described below.

In S510, physical world data of a target building is acquired, and a target relationship diagram template is determined from pre-built candidate relationship diagram templates according to the physical world data and a topology diagram generation requirement, where the physical world data includes at least complete relationship representation information of spaces, systems and devices in the target building.

In S520, container information is determined according to target physical object data corresponding to each graphic element in the target relationship diagram template, where the container information includes at least a container type and container relative position information of a graphic element in a container, and the target physical object data is determined according to the physical world data.

In S530, typesetting group content information corresponding to each typesetting group node is determined according to supervisor-subordinate relationships of typesetting group nodes and the container information.

It is to be noted that typesetting groups may be multilevel nested, and the number of levels is not limited. That is, a typesetting group may include other multiple typesetting groups or containers, so the entire typesetting issue is a “typesetting tree”. Multiple nodes of the typesetting tree have supervisor-subordinate relationships. FIG. 14 is a structural diagram of a typesetting group tree; for example, typesetting group C₁₂ and typesetting groups C₁₂₁ and C₁₂₂ have supervisor-subordinate relationships, and C₁₂ is the parent node of C₁₂₁ and C₁₂₂. A container may also serve as a typesetting group. The container is also associated with a physical object, but the typesetting group is not associated with a physical object and purely serves for typesetting. The typesetting group content information includes container type information and container number information.

In S540, typesetting group relative position information of the each typesetting group is determined according to downstream node layout information of the typesetting group nodes and the typesetting group content information corresponding to the each typesetting group node.

In the embodiment of the present application, the position of each typesetting group relative to other typesetting groups is determined through layout information of downstream node typesetting groups and the corresponding type and number of containers in the each typesetting group.

In an optional but not limited implementation, the step in which the typesetting group relative position information of the each typesetting group is determined according to the downstream node layout information of the typesetting group nodes and the typesetting group content information corresponding to the each typesetting group node includes steps C1 and C2 below.

In step C1, typesetting group relative position information of a leaf typesetting group node is determined according to leaf typesetting group node layout information and typesetting group content information corresponding to the leaf typesetting group node.

In step C2, typesetting group relative position information of upstream nodes corresponding to the leaf typesetting group node is sequentially determined according to layout information of the upstream nodes and typesetting group content information corresponding to the upstream leaf nodes until typesetting group relative position information of a root node is determined.

In the embodiment of the present application, each node on the typesetting group tree can and can only set the typesetting manner of nodes a level of nodes in the downstream of the node, and typesetting manners of nodes are set level by level in this manner, until typesetting manners of leaf nodes are set. The vertex of the canvas where the logical topology diagram is located is the top-level typesetting group by default, and each typesetting group setting a typesetting condition of typesetting groups a level of nodes in the downstream of the each typesetting group includes the content described below.

Whether the instantiation arrangement is longitudinal layout or transverse layout is set. For example, in FIG. 14, C_{K} sets whether C_{K1}, C_{K2} and C_{K3} are longitudinally laid out or transversely laid out.

If containers are transversely laid out, longitudinal positions may be set, including top alignment, bottom alignment, center alignment or center filling. That is, in FIG. 14, C_{K} may set whether C_{K1}, C_{K2} and C_{K3} within the boundary range of C_{K} are top aligned, bottom aligned, center aligned or center filled.

If containers are longitudinally laid out, transverse positions may be set, including left alignment, right alignment, center alignment or center filling. That is, in FIG. 14, C_{K} may set whether C_{K1}, C_{K2} and C_{K3} within the boundary range of C_{K} are left aligned, right aligned, center aligned or center filled.

A root node typesetting group is typeset and positioned starting from coordinate point (0, 0) by default, while the other levels of typesetting groups are sequentially typeset and positioned according to set typesetting manners and relative position distances with the root node typesetting group as a benchmark point. Continuous nested iteration is performed until coordinates of the upper left corner of the root node (the canvas) are coordinates of the origin, that is, X_{left}=0, and Yₜₒₚ=0. Then positioning is completed, and typesetting is automatically performed according to positioning results to form a diagram.

In S550, a final positioning result of multiple target graphic elements in the logical topology diagram is determined according to the typesetting group relative position information of the each typesetting group and the container relative position information of the graphic element in the container.

In the embodiment, physical world data of a target building is acquired, and a target relationship diagram template is determined from pre-built candidate relationship diagram templates according to the physical world data and a topology diagram generation requirement; container information is determined according to target physical object data corresponding to each graphic element in the target relationship diagram template; typesetting group content information corresponding to each typesetting group node is determined according to supervisor-subordinate relationships of typesetting group nodes and the container information; typesetting group relative position information of the each typesetting group is determined according to downstream node layout information of the typesetting group nodes and the typesetting group content information corresponding to the each typesetting group node; and a final positioning result of multiple target graphic elements in the logical topology diagram is determined according to the typesetting group relative position information of the typesetting group and the container relative position information of the each graphic element in the container. That is, according to the technical solutions of the embodiment, each node is drawn in the local typesetting manner through the typesetting group tree, so the graphic element in the logical topology diagram is quickly and accurately positioned.

### Embodiment Six

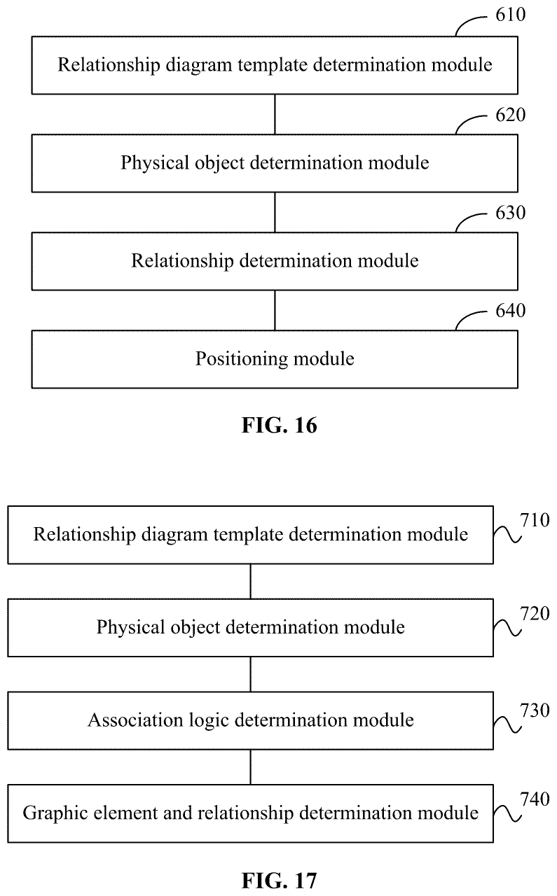

FIG. 16 is a structural diagram of an apparatus for processing graphic elements in a logical topology diagram according to embodiment six of the present disclosure. As shown in FIG. 16, the apparatus includes a relationship diagram template determination module 610, a physical object determination module 620, a relationship determination module 630 and a positioning module 640.

The relationship diagram template determination module 610 is configured to acquire physical world data of a target building, and determine a target relationship diagram template from pre-built candidate relationship diagram templates according to the physical world data and a topology diagram generation requirement, where the physical world data includes at least complete relationship representation information of spaces, systems and devices in the target building.

The physical object determination module 620 is configured to determine matched target physical object data from the physical world data according to a graphic element individual logic screening condition in the target relationship diagram template.

The relationship determination module 630 is configured to determine multiple target graphic elements and connection relationships of the multiple target graphic elements which are in the logical topology diagram corresponding to the target relationship diagram template according to the target physical object data.

The positioning module 640 is configured to determine container information according to target physical object data corresponding to each graphic element in the target relationship diagram template, and determine a final positioning result of the multiple target graphic elements in the logical topology diagram corresponding to the target relationship diagram template according to the container information, where the container information includes at least a container type and container relative position information of a graphic element in a container.

Optionally, the physical object determination module includes a static information point screening unit, a connection relationship screening unit and an individual logic screening unit.

The static information point screening unit is configured to determine the matched target physical object data from the physical world data according to a matching result between a static information point screening condition in the graphic element individual logic screening condition and candidate physical object information points in the physical world data, where the static information point screening condition includes at least one of the following logical combinations of data logic: an information point value being null or non-null, an information point value being a Boolean value, an information point value being an enumerated value, an information point value being a numerical value or an information point value being a character value.

The connection relationship screening unit is configured to determine the matched target physical object data from the physical world data according to a matching result between a connection relationship screening condition in the graphic element individual logic screening condition and candidate physical object connection relationships in the physical world data, where the connection relationship screening condition includes establishing a direct relationship or an indirect relationship with another graphic element, where the direct relationship is a preset relationship type, and the indirect relationship is level-by-level connection through at least two preset relationship types.

The individual logic screening unit is configured to determine the matched target physical object data from the physical world data according to a matching result between an overall screening condition in the graphic element individual logic screening condition and the physical world data, where the overall screening condition is a logic combination of the static information point screening condition and the connection relationship screening condition.

Optionally, the relationship determination module includes an association logic determination unit and a graphic element and relationship determination unit.

The association logic determination module is configured to determine target association logic of the target physical object data according to a graphic element association logic condition in the target relationship diagram template and the physical world data.

The graphic element and relationship determination unit is configured to determine the multiple target graphic elements and the connection relationships of the multiple target graphic elements which are in the logical topology diagram corresponding to the target relationship diagram template according to the target physical object data and the target association logic.

Optionally, the association logic determination unit includes an anchor point and connection logic determination unit and an anchor point connection information determination unit.

The anchor point and connection logic determination unit is configured to determine an anchor point of the each graphic element in the target relationship diagram template and candidate connection logic in the target relationship diagram template according to the graphic element association logic condition in the target relationship diagram template.

The anchor point connection information determination unit is configured to determine, according to the physical world data and the anchor point of the each graphic element in the target relationship diagram template and the candidate connection logic in the target relationship diagram template, anchor point connection information of the each graphic element as the target association logic of the target physical object data.

Optionally, the graphic element and relationship determination unit includes a target relationship network determination unit and a completeness judgement unit.

The target relationship network determination unit is configured to determine a target relationship network according to the multiple target graphic elements and the connection relationships of the multiple target graphic elements.

The completeness judgement unit is configured to judge rationality of the target relationship network according to a data link condition, and determine accuracy of the logical topology diagram corresponding to the target relationship diagram template according to the rationality of the target relationship network, where the data link condition includes that the target relationship network does not include an independent relationship network, and the target relationship network does not include circular relationship logic.

Optionally, the positioning module includes a relative position determination unit and a graphic positioning determination unit.

The relative position determination unit is configured to determine, based on node typesetting information in a typesetting group tree corresponding to the target relationship diagram template, typesetting group relative position information of each typesetting group according to the container information, where the typesetting group tree includes at least one another typesetting group or at least one container.

The graphic positioning determination unit is configured to determine the final positioning result of the multiple target graphic elements in the logical topology diagram corresponding to the target relationship diagram template according to the typesetting group relative position information of the each typesetting group and the container relative position information of the graphic element in the container.

Optionally, the positioning module includes a container information determination unit. The container information determination unit includes a container type determination unit and a container relative position determination unit.

The container type determination unit is configured to determine, according to the target physical object data corresponding to the each graphic element, the container type and graphic element attribute information in the container after instantiation, where the graphic element attribute information includes a physical object to which the each graphic element corresponds and the number of graphic elements.

The container relative position determination unit is configured to determine corresponding container typesetting and layout information according to the container type, and determine the container relative position information of the graphic element in the container according to the container typesetting and layout information and the graphic element attribute information.

Optionally, the relative position determination unit includes a typesetting group content determination unit and a typesetting group relative position determination unit.

The typesetting group content determination unit is configured to determine typesetting group content information corresponding to each typesetting group node according to supervisor-subordinate relationships of typesetting group nodes and the container information.

The typesetting group relative position determination unit is configured to determine the typesetting group relative position information of the each typesetting group according to downstream node layout information of the typesetting group nodes and the typesetting group content information corresponding to the each typesetting group node.

Optionally, the typesetting group relative position determination unit performs the steps described below.

Typesetting group relative position information of a leaf typesetting group node is determined according to leaf typesetting group node layout information and typesetting group content information corresponding to the leaf typesetting group node.

Typesetting group relative position information of upstream nodes corresponding to the leaf typesetting group node are sequentially determined according to layout information of the upstream nodes and typesetting group content information corresponding to the upstream nodes until typesetting group relative position information of a root node is determined.

Optionally, the graphic positioning determination unit includes a root node absolute position determination unit, a typesetting group absolute position determination unit and a graphic element absolute position determination unit.

The root node absolute position determination unit is configured to determine absolute position information of the root node.

The typesetting group absolute position determination unit is configured to sequentially determine, based on the absolute position information of the root node, typesetting group absolute position information of downstream nodes of the root node according to the typesetting group relative position information of the each typesetting group.

The graphic element absolute position determination unit is configured to determine, according to the typesetting group absolute position information and the container relative position information of the each graphic element in the container, graphic element absolute position information of the multiple target graphic elements in the logical topology diagram as the final positioning result.

The apparatus for processing graphic elements in a logical topology diagram provided in the embodiment of the present disclosure may perform the method for processing graphic elements in a logical topology diagram provided in any embodiment of the present disclosure and has function modules and beneficial effects corresponding to the method performed.

In the technical solutions of the present application, the acquisition, storage, use and processing of data are in compliance with relevant provisions of national laws and regulations and do not violate public order and good customs.

### Embodiment Seven

FIG. 17 is a structural diagram of an apparatus for determining graphic elements in a logical topology diagram according to embodiment seven of the present disclosure. As shown in FIG. 17, the apparatus includes a relationship diagram template determination module 710, a physical object determination module 720, an association logic determination module 730 and a graphic element and relationship determination module 740.

The relationship diagram template determination module 710 is configured to acquire physical world data of a target building, and determine a target relationship diagram template from pre-built candidate relationship diagram templates according to the physical world data and a topology diagram generation requirement, where the physical world data includes at least complete relationship representation information of spaces, systems and devices in the target building.

The physical object determination module 720 is configured to determine matched target physical object data from the physical world data according to a graphic element individual logic screening condition in the target relationship diagram template.

The association logic determination module 730 is configured to determine target association logic of the target physical object data according to a graphic element association logic condition in the target relationship diagram template and the physical world data.

The graphic element and relationship determination module 740 is configured to determine multiple target graphic elements and connection relationships of the multiple target graphic elements which are in a logical topology diagram corresponding to the target relationship diagram template according to the target physical object data and the target association logic.

Optionally, the physical object determination module includes a static information point screening unit, a connection relationship screening unit and an individual logic screening unit.

The static information point screening unit is configured to determine the matched target physical object data from the physical world data according to a matching result between a static information point screening condition in the graphic element individual logic screening condition and candidate physical object information points in the physical world data, where the static information point screening condition includes at least one of the following logical combinations of data logic: an information point value being null or non-null, an information point value being a Boolean value, an information point value being an enumerated value, an information point value being a numerical value or an information point value being a character value.

The connection relationship screening unit is configured to determine the matched target physical object data from the physical world data according to a matching result between a connection relationship screening condition in the graphic element individual logic screening condition and candidate physical object connection relationships in the physical world data, where the connection relationship screening condition includes establishing a direct relationship or an indirect relationship with another graphic element, where the direct relationship is a preset relationship type, and the indirect relationship is level-by-level connection through at least two preset relationship types.

The individual logic screening unit is configured to determine the matched target physical object data from the physical world data according to a matching result between an overall screening condition in the graphic element individual logic screening condition and the physical world data, where the overall screening condition is a logic combination of the static information point screening condition and the connection relationship screening condition.

Optionally, the association logic determination module includes an anchor point and connection logic determination unit and an anchor point connection information determination unit.

The anchor point and connection logic determination unit is configured to determine an anchor point of the each graphic element in the target relationship diagram template and candidate connection logic in the target relationship diagram template according to the graphic element association logic condition in the target relationship diagram template.

The anchor point connection information determination unit is configured to determine, according to the physical world data and the anchor point of the each graphic element in the target relationship diagram template and the candidate connection logic in the target relationship diagram template, anchor point connection information of the each graphic element as the target association logic of the target physical object data.

Optionally, the graphic element and relationship determination module includes a target relationship network determination unit and a completeness judgement unit.

The target relationship network determination unit is configured to determine a target relationship network according to the multiple target graphic elements and the connection relationships of the multiple target graphic elements.

The completeness judgement unit is configured to judge rationality of the target relationship network according to a data link condition, and determine accuracy of the logical topology diagram corresponding to the target relationship diagram template according to the rationality of the target relationship network, where the data link condition includes that the target relationship network does not include an independent relationship network, and the target relationship network does not include circular relationship logic.

The apparatus for determining graphic elements in a logical topology diagram provided in the embodiment of the present disclosure may perform the method for determining graphic elements in a logical topology diagram provided in any embodiment of the present disclosure and has function modules and beneficial effects corresponding to the method performed.

In the technical solutions of the present application, the acquisition, storage, use and processing of data are in compliance with relevant provisions of national laws and regulations and do not violate public order and good customs.

### Embodiment Eight

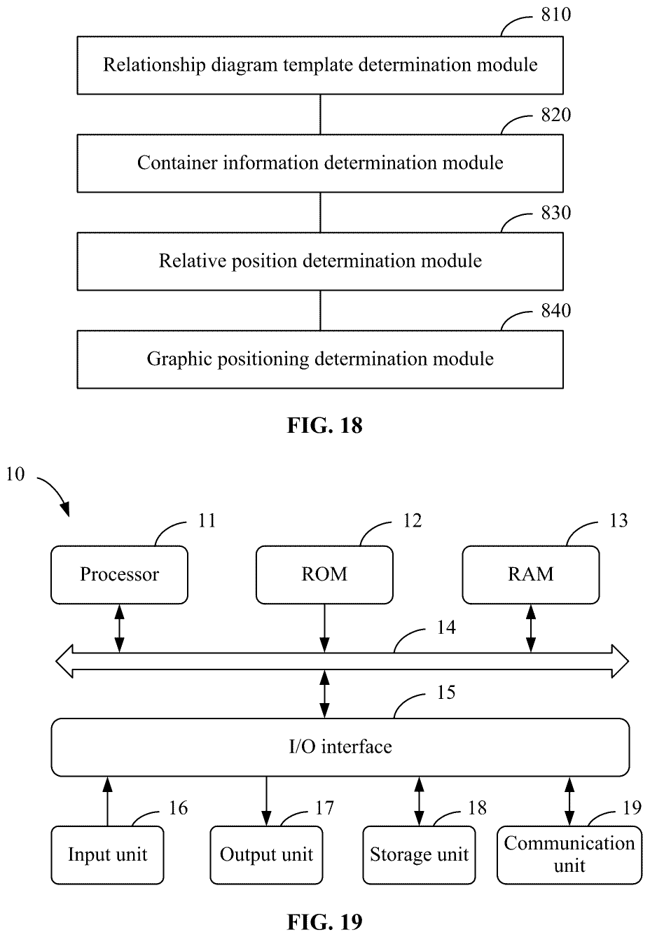

FIG. 18 is a structural diagram of a positioning apparatus of graphic elements in a logical topology diagram according to embodiment eight of the present disclosure. As shown in FIG. 18, the apparatus includes a relationship diagram template determination module 810, a container information determination module 820, a relative position determination module 830 and a graphic positioning determination module 840.

The relationship diagram template determination module 810 is configured to acquire physical world data of a target building, and determine a target relationship diagram template from pre-built candidate relationship diagram templates according to the physical world data and a topology diagram generation requirement, where the physical world data includes at least complete relationship representation information of spaces, systems and devices in the target building.

The container information determination module 820 is configured to determine container information according to target physical object data corresponding to each graphic element in the target relationship diagram template, where the container information includes at least a container type and container relative position information of a graphic element in a container, and the target physical object data is determined according to the physical world data.

The relative position determination module 830 is configured to determine, based on node typesetting information in a typesetting group tree corresponding to the target relationship diagram template, typesetting group relative position information of each typesetting group according to the container information, where the typesetting group tree includes at least one another typesetting group or at least one container.

The graphic positioning determination module 840 is configured to determine a final positioning result of the multiple target graphic elements in the logical topology diagram according to the typesetting group relative position information of the each typesetting group and the container relative position information of the graphic element in the container.

Optionally, the container information determination module includes a container type determination unit and a container relative position determination unit.

The container type determination unit is configured to determine, according to the target physical object data corresponding to the each graphic element, the container type and graphic element attribute information in the container after instantiation, where the graphic element attribute information includes a physical object to which the each graphic element corresponds and the number of graphic elements.

The container relative position determination unit is configured to determine corresponding container typesetting and layout information according to the container type, and determine the container relative position information of the graphic element in the container according to the container typesetting and layout information and the graphic element attribute information.

Optionally, the relative position determination module includes a typesetting group content determination unit and a typesetting group relative position determination unit.

The typesetting group content determination unit is configured to determine typesetting group content information corresponding to each typesetting group node according to supervisor-subordinate relationships of typesetting group nodes and the container information.

The typesetting group relative position determination unit is configured to determine the typesetting group relative position information of the each typesetting group according to downstream node layout information of the typesetting group nodes and the typesetting group content information corresponding to the each typesetting group node.

Optionally, the typesetting group relative position determination unit performs the steps described below.

Typesetting group relative position information of a leaf typesetting group node is determined according to leaf typesetting group node layout information and typesetting group content information corresponding to the leaf typesetting group node.

Typesetting group relative position information of upstream nodes corresponding to the leaf typesetting group node are sequentially determined according to layout information of the upstream nodes and typesetting group content information corresponding to the upstream nodes until typesetting group relative position information of a root node is determined.

Optionally, the graphic positioning determination module includes a root node absolute position determination unit, a typesetting group absolute position determination unit and a graphic element absolute position determination unit.

The root node absolute position determination unit is configured to determine absolute position information of the root node.

The typesetting group absolute position determination unit is configured to sequentially determine, based on the absolute position information of the root node, typesetting group absolute position information of downstream nodes of the root node according to the typesetting group relative position information of the each typesetting group.

The graphic element absolute position determination unit is configured to determine, according to the typesetting group absolute position information and the container relative position information of the graphic element in the container, graphic element absolute position information of the multiple target graphic elements in the logical topology diagram as the final positioning result.

The positioning apparatus of graphic elements in a logical topology diagram provided in the embodiment of the present disclosure may perform the method for positioning graphic elements in a logical topology diagram provided in any embodiment of the present disclosure and has function modules and beneficial effects corresponding to the method performed.

In the technical solutions of the present application, the acquisition, storage, use and processing of data are in compliance with relevant provisions of national laws and regulations and do not violate public order and good customs.

### Embodiment Nine

According to the embodiment nine of the present disclosure, the present disclosure further provides an electronic device, a readable storage medium and a computer program product.

FIG. 19 is a structural diagram of an electronic device 10 for implementing the embodiments of the present disclosure. The electronic device is intended to represent various forms of digital computers, for example, a laptop computer, a desktop computer, a worktable, a personal digital assistant, a server, a blade server, a mainframe computer or another applicable computer. The electronic device may also represent various forms of mobile apparatuses, for example, a personal digital assistant, a cellphone, a smartphone, a wearable device (such as a helmet, glasses and a watch) or another similar computing apparatus. Herein the shown components, the connections and relationships between these components, and the functions of these components are illustrative and are not intended to limit the implementation of the present disclosure as described and/or claimed herein.

As shown in FIG. 19, the electronic device 10 includes at least one processor 11 and a memory (such as a read-only memory (ROM) 12 and a random-access memory (RAM) 13) communicatively connected to the at least one processor 11. The memory stores a computer program executable by the at least one processor. The processor 11 may perform various types of appropriate operations and processing according to a computer program stored in the read-only memory (ROM) 12 or a computer program loaded from a storage unit 18 to the random-access memory (RAM) 13. Various programs and data required for the operation of the electronic device 10 are also stored in the RAM 13. The processor 11, the ROM 12 and the RAM 13 are connected to each other through a bus 14. An input/output (I/O) interface 15 is also connected to the bus 14.

Multiple components in the electronic device 10 are connected to the I/O interface 15. The multiple components include an input unit 16 such as a keyboard or a mouse, an output unit 17 such as various types of displays or speakers, the storage unit 18 such as a magnetic disk or an optical disc, and a communication unit 19 such as a network card, a modem or a wireless communication transceiver. The communication unit 19 allows the electronic device 10 to exchange information/data with other devices over a computer network such as the Internet and/or various telecommunications networks.

The processor 11 may be various general-purpose and/or special-purpose processing components having processing and computing capabilities. Examples of the processor 11 include, but are not limited to, a central processing unit (CPU), a graphics processing unit (GPU), a special-purpose artificial intelligence (AI) computing chip, a processor executing machine learning models and algorithms, a digital signal processor (DSP) and any appropriate processor, controller and microcontroller. The processor 11 performs various methods and processing described above, such as the method for processing graphic elements in a logical topology diagram, the method for determining graphic elements in a logical topology diagram or the method for positioning graphic elements in a logical topology diagram.

In some embodiments, the method for processing graphic elements in a logical topology diagram, the method for determining graphic elements in a logical topology diagram or the method for positioning graphic elements in a logical topology diagram may be implemented as computer software programs tangibly contained in a computer-readable storage medium such as the storage unit 18. In some embodiments, part or all of computer programs may be loaded and/or installed onto the electronic device 10 via the ROM 12 and/or the communication unit 19. When the computer programs are loaded to the RAM 103 and performed by the processor 101, one or more steps of the method for processing graphic elements in a logical topology diagram, the method for determining graphic elements in a logical topology diagram or the method for positioning graphic elements in a logical topology diagram described above may be performed. Alternatively, in other embodiments, the processor 101 may be configured, in any other suitable manner (for example, by means of firmware), to perform the method for processing graphic elements in a logical topology diagram, the method for determining graphic elements in a logical topology diagram or the method for positioning graphic elements in a logical topology diagram.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software and/or combinations thereof. These embodiments may include implementations in one or more computer programs. The one or more computer programs may be executable and/or interpretable on a programmable system including at least one programmable processor. A programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Computer programs for implementation of the methods of the present disclosure may be written in one programming language or any combination of multiple programming languages. These computer programs may be provided for a processor of a general-purpose computer, a special-purpose computer or another programmable data processing apparatus such that the computer programs, when executed by the processor, cause functions/operations specified in the flowcharts and/or block diagrams to be implemented. The computer programs may be executed entirely on a machine, partly on a machine, as a stand-alone software package partly on a machine and partly on a remote machine, or entirely on a remote machine or a server.

In the context of the present disclosure, the computer-readable storage medium may be a tangible medium including or storing a computer program that is used by or used in conjunction with an instruction execution system, apparatus or device. The computer-readable storage medium may include, but is not limited to, an electronic, magnetic, optical, electromagnetic, infrared or semiconductor system, apparatus or device or any appropriate combination thereof. Alternatively, the computer-readable storage medium may be a machine-readable signal medium. Concrete examples of the machine-readable storage medium include an electrical connection based on one or more wires, a portable computer disk, a hard disk, a random-access memory (RAM), a read-only memory (ROM), an erasable programmable read-only memory (EPROM), a flash memory, an optical fiber, a portable compact disc read-only memory (CD-ROM), an optical storage device, a magnetic storage device or any suitable combination thereof.

In order that interaction with a user is provided, the systems and techniques described herein may be implemented on the electronic device. The electronic device has a display apparatus (for example, a cathode-ray tube (CRT) or a liquid-crystal display (LCD) monitor) for displaying information to the user; and a keyboard and a pointing apparatus (for example, a mouse or a trackball) through which the user can provide input for the electronic device. Other types of apparatuses may also be used for providing interaction with a user. For example, feedback provided for the user may be sensory feedback in any form (for example, visual feedback, auditory feedback or tactile feedback); and input from the user may be received in any form (including acoustic input, voice input or tactile input).

The systems and techniques described herein may be implemented in a computing system including a back-end component (for example, a data server), a computing system including an exchange component (for example, an application server), a computing system including a front-end component (for example, a user computer having a graphical user interface or a web browser through which a user can interact with embodiments of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a conventional physical host and virtual private server (VPS) services.

It is to be understood that various forms of the preceding flows may be used, with steps reordered, added or removed. For example, the steps described in the present disclosure may be performed in parallel, in sequence or in a different order as long as the desired results of the technical solutions of the present disclosure can be achieved. The execution sequence of these steps is not limited herein.

The preceding embodiments are not intended to limit the scope of the present disclosure. It is to be understood by those skilled in the art that various modifications, combinations, subcombinations and substitutions may be made according to design requirements and other factors. Any modification, equivalent substitution or improvement made within the spirit and principle of the present disclosure falls within the scope of the present disclosure.

What is claimed is:

1. A method for processing graphic elements in a logical topology diagram, comprising:
acquiring physical world data of a target building, and determining a target relationship diagram template from pre-built candidate relationship diagram templates according to the physical world data and a topology diagram generation requirement, wherein the physical world data comprises at least complete relationship representation information of spaces, systems and devices in the target building;
determining matched target physical object data from the physical world data according to a graphic element individual logic screening condition in the target relationship diagram template;
determining a plurality of target graphic elements and connection relationships of the plurality of target graphic elements which are in the logical topology diagram corresponding to the target relationship diagram template according to the target physical object data; and
determining container information according to target physical object data corresponding to each graphic element in the target relationship diagram template, and determining a final positioning result of the plurality of target graphic elements in the logical topology diagram corresponding to the target relationship diagram template according to the container information, wherein the container information comprises at least a container type and container relative position information of a graphic element in a container.

2. The method according to claim 1, wherein determining the matched target physical object data from the physical world data according to the graphic element individual logic screening condition in the target relationship diagram template comprises:
determining the matched target physical object data from the physical world data according to a matching result between a static information point screening condition in the graphic element individual logic screening condition and candidate physical object information points in the physical world data, wherein
the static information point screening condition comprises at least one of the following logical combinations of data logic: an information point value being null or non-null, an information point value being a Boolean value, an information point value being an enumerated value, an information point value being a numerical value or an information point value being a character value.

3. The method according to claim 2, wherein determining the matched target physical object data from the physical world data according to the graphic element individual logic screening condition in the target relationship diagram template comprises:
determining the matched target physical object data from the physical world data according to a matching result between a connection relationship screening condition in the graphic element individual logic screening condition and candidate physical object connection relationships in the physical world data, wherein
the connection relationship screening condition comprises establishing a direct relationship or an indirect relationship with another graphic element, wherein the direct relationship is a preset relationship type, and the indirect relationship is level-by-level connection through at least two preset relationship types.

4. The method according to claim 3, wherein determining the matched target physical object data from the physical world data according to the graphic element individual logic screening condition in the target relationship diagram template comprises:
determining the matched target physical object data from the physical world data according to a matching result between an overall screening condition in the graphic element individual logic screening condition and the physical world data, wherein
the overall screening condition is a logic combination of the static information point screening condition and the connection relationship screening condition.

5. The method according to claim 1, wherein determining the plurality of target graphic elements and the connection relationships of the plurality of target graphic elements which are in the logical topology diagram corresponding to the target relationship diagram template according to the target physical object data comprises:
determining target association logic of the target physical object data according to a graphic element association logic condition in the target relationship diagram template and the physical world data; and
determining the plurality of target graphic elements and the connection relationships of the plurality of target graphic elements which are in the logical topology diagram corresponding to the target relationship diagram template according to the target physical object data and the target association logic.

6. The method according to claim 5, wherein determining the target association logic of the target physical object data according to the graphic element association logic condition in the target relationship diagram template and the physical world data comprises:
determining an anchor point of the each graphic element in the target relationship diagram template and candidate connection logic in the target relationship diagram template according to the graphic element association logic condition in the target relationship diagram template; and
determining, according to the physical world data and the anchor point of the each graphic element in the target relationship diagram template and the candidate connection logic in the target relationship diagram template, anchor point connection information of the each graphic element as the target association logic of the target physical object data.

7. The method according to claim 6, wherein the graphic element association logic condition comprises: anchor point connection exists between two graphic elements of different types, a same connection relationship between two graphic elements corresponds to connection between a pair of anchor points, a connection relationship between the pair of anchor points comprises a direction relationship or an indirect relationship, an anchor point of the pair of anchor points represents a reference physical object, and information of the anchor point comprises association logic between the reference physical object and a graphic element corresponding to the anchor point, wherein
the direction relationship is a preset relationship type, and the indirect relationship is level-by-level connection through at least two preset relationship types.

8. The method according to claim 1, after determining the plurality of target graphic elements and the connection relationships of the plurality of target graphic elements which are in the logical topology diagram corresponding to the target relationship diagram template, further comprising:
determining a target relationship network according to the plurality of target graphic elements and the connection relationships of the plurality of target graphic elements; and
judging rationality of the target relationship network according to a data link condition, and determining accuracy of the logical topology diagram corresponding to the target relationship diagram template according to the rationality of the target relationship network, wherein
the data link condition comprises that the target relationship network does not comprise an independent relationship network, and the target relationship network does not comprise circular relationship logic;
wherein determining the final positioning result of the plurality of target graphic elements in the logical topology diagram corresponding to the target relationship diagram template according to the container information comprises:
determining, based on node typesetting information in a typesetting group tree corresponding to the target relationship diagram template, typesetting group relative position information of each typesetting group according to the container information, wherein the typesetting group tree comprises at least one another typesetting group or at least one container; and
determining the final positioning result of the plurality of target graphic elements in the logical topology diagram corresponding to the target relationship diagram template according to the typesetting group relative position information of the each typesetting group and the container relative position information of the graphic element in the container.

9. A method for determining graphic elements in a logical topology diagram, comprising:
acquiring physical world data of a target building, and determining a target relationship diagram template from pre-built candidate relationship diagram templates according to the physical world data and a topology diagram generation requirement, wherein the physical world data comprises at least complete relationship representation information of spaces, systems and devices in the target building;
determining matched target physical object data from the physical world data according to a graphic element individual logic screening condition in the target relationship diagram template;
determining target association logic of the target physical object data according to a graphic element association logic condition in the target relationship diagram template and the physical world data; and
determining a plurality of target graphic elements and connection relationships of the plurality of target graphic elements which are in the logical topology diagram corresponding to the target relationship diagram template according to the target physical object data and the target association logic.

10. The method according to claim 9, wherein determining the matched target physical object data from the physical world data according to the graphic element individual logic screening condition in the target relationship diagram template comprises:
determining the matched target physical object data from the physical world data according to a matching result between a static information point screening condition in the graphic element individual logic screening condition and candidate physical object information points in the physical world data, wherein
the static information point screening condition comprises at least one of the following logical combinations of data logic: an information point value being null or non-null, an information point value being a Boolean value, an information point value being an enumerated value, an information point value being a numerical value or an information point value being a character value.

11. The method according to claim 10, wherein determining the matched target physical object data from the physical world data according to the graphic element individual logic screening condition in the target relationship diagram template comprises:
determining the matched target physical object data from the physical world data according to a matching result between a connection relationship screening condition in the graphic element individual logic screening condition and candidate physical object connection relationships in the physical world data, wherein
the connection relationship screening condition comprises establishing a direct relationship or an indirect relationship with another graphic element, wherein the direct relationship is a preset relationship type, and the indirect relationship is level-by-level connection through at least two preset relationship types;
wherein determining the matched target physical object data from the physical world data according to the graphic element individual logic screening condition in the target relationship diagram template comprises:
determining the matched target physical object data from the physical world data according to a matching result between an overall screening condition in the graphic element individual logic screening condition and the physical world data, wherein
the overall screening condition is a logic combination of the static information point screening condition and the connection relationship screening condition.

12. The method according to claim 9, wherein determining the target association logic of the target physical object data according to the graphic element association logic condition in the target relationship diagram template and the physical world data comprises:
determining an anchor point of each graphic element in the target relationship diagram template and candidate connection logic in the target relationship diagram template according to the graphic element association logic condition in the target relationship diagram template; and
determining, according to the physical world data and the anchor point of the each graphic element in the target relationship diagram template and the candidate connection logic in the target relationship diagram template, anchor point connection information of the each graphic element as the target association logic of the target physical object data;
wherein the graphic element association logic condition comprises: anchor point connection exists between two graphic elements of different types, a same connection relationship between two graphic elements corresponds to connection between a pair of anchor points, a connection relationship between the pair of anchor points comprises a direction relationship or an indirect relationship, an anchor point of the pair of anchor points represents a reference physical object, and information of the anchor point comprises association logic between the reference physical object and a graphic element corresponding to the anchor point, wherein
the direction relationship is a preset relationship type, and the indirect relationship is level-by-level connection through at least two preset relationship types.

13. The method according to claim 9, after determining the plurality of target graphic elements and the connection relationships of the plurality of target graphic elements which are in the logical topology diagram corresponding to the target relationship diagram template, further comprising:
determining a target relationship network according to the plurality of target graphic elements and the connection relationships of the plurality of target graphic elements; and
judging rationality of the target relationship network according to a data link condition, and determining accuracy of the logical topology diagram corresponding to the target relationship diagram template according to the rationality of the target relationship network, wherein
the data link condition comprises that the target relationship network does not comprise an independent relationship network, and the target relationship network does not comprise circular relationship logic.

14. A method for positioning graphic elements in a logical topology diagram, comprising:
acquiring physical world data of a target building, and determining a target relationship diagram template from pre-built candidate relationship diagram templates according to the physical world data and a topology diagram generation requirement, wherein the physical world data comprises at least complete relationship representation information of spaces, systems and devices in the target building;
determining container information according to target physical object data corresponding to each graphic element in the target relationship diagram template, wherein the container information comprises at least a container type and container relative position information of a graphic element in a container, and the target physical object data is determined according to the physical world data;
determining, based on node typesetting information in a typesetting group tree corresponding to the target relationship diagram template, typesetting group relative position information of each typesetting group according to the container information, wherein the typesetting group tree comprises at least one another typesetting group or at least one container; and
determining a final positioning result of a plurality of target graphic elements in the logical topology diagram according to the typesetting group relative position information of the each typesetting group and the container relative position information of the graphic element in the container.

15. The method according to claim 14, wherein determining the container information according to the target physical object data corresponding to the each graphic element in the target relationship diagram template comprises:
determining, according to the target physical object data corresponding to the each graphic element, the container type and graphic element attribute information in the container after instantiation, wherein the graphic element attribute information comprises a physical object to which the each graphic element corresponds and a number of graphic elements; and
determining corresponding container typesetting and layout information according to the container type, and determining the container relative position information of the graphic element in the container according to the container typesetting and layout information and the graphic element attribute information.

16. The method according to claim 14, wherein the node typesetting information in the typesetting group tree comprises supervisor-subordinate relationships of typesetting group nodes and downstream node layout information of the typesetting group nodes, wherein
the supervisor-subordinate relationships of the typesetting group nodes represent nested relationships of typesetting groups;
wherein determining, based on the node typesetting information in the typesetting group tree corresponding to the target relationship diagram template, the typesetting group relative position information of the each typesetting group according to the container information comprises:
determining typesetting group content information corresponding to each typesetting group node according to the supervisor-subordinate relationships of the typesetting group nodes and the container information; and
determining the typesetting group relative position information of the each typesetting group according to the downstream node layout information of the typesetting group nodes and the typesetting group content information corresponding to the each typesetting group node.

17. The method according to claim 16, wherein determining the typesetting group relative position information of the each typesetting group according to the downstream node layout information of the typesetting group nodes and the typesetting group content information corresponding to the each typesetting group node comprises:
determining typesetting group relative position information of a leaf typesetting group node according to leaf typesetting group node layout information and typesetting group content information corresponding to the leaf typesetting group node; and
sequentially determining, according to layout information of upstream nodes corresponding to the leaf typesetting group node and typesetting group content information corresponding to the upstream nodes, typesetting group relative position information of the upstream nodes until typesetting group relative position information of a root node is determined;
wherein determining a final positioning result of the plurality of target graphic elements in the logical topology diagram according to the typesetting group relative position information of the each typesetting group and the container relative position information of the graphic element in the container comprises:
determining absolute position information of the root node;
sequentially determining, based on the absolute position information of the root node, typesetting group absolute position information of downstream nodes of the root node according to the typesetting group relative position information of the each typesetting group; and
determining, according to the typesetting group absolute position information and the container relative position information of the graphic element in the container, graphic element absolute position information of the plurality of target graphic elements in the logical topology diagram as the final positioning result.

18. An electronic device, comprising:
at least one processor; and
a memory communicatively connected to the at least one processor;
wherein the memory stores a computer program executable by the at least one processor, and the computer program is executed by the at least one processor to cause the at least one processor to perform the method according to claim 1.

19. An electronic device, comprising:
at least one processor; and
a memory communicatively connected to the at least one processor;
wherein the memory stores a computer program executable by the at least one processor, and the computer program is executed by the at least one processor to cause the at least one processor to perform the method for processing graphic elements in a logical topology diagram according to according to claim 9.

20. An electronic device, comprising:
at least one processor; and
a memory communicatively connected to the at least one processor;
wherein the memory stores a computer program executable by the at least one processor, and the computer program is executed by the at least one processor to cause the at least one processor to perform the method for processing graphic elements in a logical topology diagram according to claim 14.
